(19) United States
(12) Patent Application Publication
(10) Pub. No.: US 2024/0346096 A1
(43) Pub. Date: Oct. 17, 2024

(54) PERSONAL HELPER BOT SYSTEM WITH EXAMPLE APPLICATIONS IN GENEALOGY AND MUSIC PLAYLIST CURATION

(71) Applicants: Bertrand Barrett, Lawrenceville, GA (US); Charles L Sessions, Copiague, NY (US); Wanda Jerri Hill, Wylie, TX (US)

(72) Inventors: Bertrand Barrett, Lawrenceville, GA (US); Charles L Sessions, Copiague, NY (US); Wanda Jerri Hill, Wylie, TX (US)

(21) Appl. No.: 18/595,370

(22) Filed: Mar. 4, 2024

Related U.S. Application Data
(63) Continuation-in-part of application No. 16/454,031, filed on Jun. 26, 2019.

(51) Int. Cl. G06F 16/9535; G06F 16/9538; G06F 21/32

(52) U.S. Cl. CPC G06F 16/9535; G06F 16/9538; G06F 21/32

(57) ABSTRACT

The present invention is a personal helper autonomous BOTs (microservices) system, providing a unified database search application on a single device, and eliminating the need for multiple, time-consuming database searches. This system enables conversational interactions using natural language to orchestrate the work of a team of BOTs that perform internet-based tasks. These BOTs collaborate to enhance efficiency and productivity in otherwise labor-intensive endeavors. The system prowess, exemplified through the performance of genealogical searches and the curation of music playlists, involves streamlining tasks traditionally requiring extensive manual searches across various databases and/or the use of multiple applications. By incorporating case-based reasoning machine learning AI algorithms, the system learns from BOT collaborations, thereby improving its performance and reusability over time.

### FIELD OF THE INVENTION

The present invention relates to intelligent systems, particularly for classes of applications that pertain to intelligent automated assistants, autonomous agents, digital libraries, search engines and BOTs.

### BACKGROUND OF THE INVENTION

### Background of the Invention—Television and Other Devices

Today, it seems we separate the platforms by which we experience passive entertainment activities from interactive computing applications and activities. The United. States, by way of example, ranks the highest among other countries in the amount of time that is spent by individuals watching television. In addition, it is also ranked among the lowest in the same countries as far as the average score by 12^{th} graders on standardized tests. There is a strong hint that there is some correlation between the two. It is believe, however, that if interactive Television however, provided channels with seamlessly integrated applications and computing services, and it became the platform by which our students synthesized reports, conducted research, or could easily satisfy a request to instantly learn about a topic of interest (with definitions and video demonstrations), then perhaps there could be a greater academic return on the amount of time, for example, Americans already invest in television screen watching. Although there has been some progress with set top boxes and gaming interfaces, cable TV channel selection interfaces and guides do not offer much in the way of integrated interactive applications and services the way smart phones do. The massive investment of time that we spend in front of the TV can become a more interactive television experience that is closer to how we interact with our smart phone apps.

This experience would foster a healthier mix of both passive and interactive channels. It could feature verbal interaction with a personal assistant (in the form of an avatar) that helps users to be more efficient by processing their requests for services and dispatching the required tasks'. At least one of the channels could be Internet access with all the enabling plug-ins for video and chat. There could be gaming and teleconferencing channels as well. There would most certainly be a channel just for robust searches.

Historically, search engines do not permit a dynamic, flexible, and/or personalized process. Furthermore, as the number of applications we use increases with as many consumer devices, smart phones, tablet computers, and the like, that are able to run software applications to perform various tasks and provide different types of information, the ability for users to master them all and supply information to them becomes unwieldy.

### Background of the Invention—Genealogy

Genealogical research traditionally involves conducting multiple database searches, leading to considerable time and effort wastage. Existing systems lack the integration required for efficient genealogy searches. The existing technology used in genealogical research suffers from inefficiencies due to the disjointed nature of database searches. Current systems also lack a unified framework to streamline the research process and optimize search efficiency.

### Background of the Invention—Music Playlist Curation

Artist have historically faced challenges in finding and connecting with playlist curators on music streaming platforms. There is a lack of strategies and best practices that artists can use to locate and build relationships with playlist curators effectively. With this deficiency, aspiring and established artists, who wish to promote their music on streaming platforms and enhance their visibility to potential listeners, are at a disadvantage. Without significant use of resources, such artists cannot obtain information that they can trust to accurately describe their target audience and have difficulty developing lists of compatible playlist curators in real time.

### SUMMARY

### Summary of the Invention—Television and Other Devices

The problems outlined above are slated to be addressed by the present invention. Personal Helper BOTs are intended to provide the deep personalization and rich interactivity that the consumer craves by referencing a user's profile and behavior, resulting in delivery of information products and services much more relevant and valuable to the user than we may experience currently. Both online and mobile users will become increasingly reliant on BOTs in place of or in concert with search engines, to procure relevant information. These Personal Helper BOTs will have the ability to automate human-like reasoning and problem-solving, and better analyze and predict our needs for digital content.

Many more providers of digital content will be offering their own BOT virtual assistants and “smart” apps offering services that mirror how you would interact with a sales assistant that already knows you very well and thus would be able to recommend or advise you on products and services. BOT empowered searches increase depth and breadth by direct access to libraries of digitized multimedia content in addition to the World Wide Web and for interactive television embodiments, the obvious database of TV programs or movies native to cable television. Personal Helper BOT powered searches could be assisted by a wizard at creation time, also allowing for customization of search results and their integration into living documents such as reports, spreadsheets, and/or business presentations, etc. These searches can be reversed, bringing about alerts that can be extremely timely and helpful to people that use this feature. All alert information and task completion status information from Personal Helper BOTs can be delivered by the avatar or directly by email, text, smart phone applications all integrated by one entertainment operating system and delivered on your flat screen television, gaming interface, laptop, tablet, car dashboard interface, or smart phone.

According to various embodiments of the present invention, a Personal Helper BOT system can be implemented, for example, on an output device such as a big screen television enabled by a TV based browser to provide for example, a MyBOTs.Tv web site and its BOT products and services to the consumer. In various embodiments, the Personal Helper BOT system utilizes a customizable personal assistant in the form of an avatar to engage its owner in a conversational manner to coordinate activity of a team of autonomous Personal Helper BOTs. Among a variety of other tasks, BOTs collaborate to create the owner's schedule, maintain his/her to-do list, obtain personally interesting information, automate personalized services, perform web site transactions to satisfy goals, leverage web apps as tools, conduct research, curate content and complete tasks and/or synthesize useful products and documents for their users.

According to various embodiments of the present invention, the Personal Helper BOT system coordinates the individual activities of autonomous web robots (each of which specializes in its own function) such that the net effect is teamwork and the owner's ultimate personal help solution. In short, the goal here is foremost to assist by offloading the task from the user before finding ways to assist the user with the task. In some embodiments, BOTs will learn to do a task autonomously—thereby removing the need to assist with it because it has learned how to do it completely.

Furthermore, the Personal Helper BOT system of the present invention may, in at least some embodiments, coordinate the team of BOTs in ways that serve the owner in achieving more focused and/or complex goals than would otherwise be provided by any single BOT's services.

The underlying components—an agent-aware Digital Library Architecture, a user directed search filter, a system of Personal Helper BOTs, and an interactive avatar interface with BOT security architectures are disclosed herein.

According to various embodiments of the present invention, intelligent Personal Helper BOT systems may be configured to provide different types of operations, functionalities, features, applications and/or products, and/or to combine a plurality of features, operations, functionalities, applications, or reusable programs by way of a device on which it is installed. In some embodiments, the Personal Helper BOT systems of the present invention can perform any or all of (1) actively eliciting service requests from a user, (2) interpreting inputted user directives or intents. (3) disambiguating among competing directives, (4) requesting and receiving clarifying directives or canceling directives as needed, and (5) carrying out or initiating service requests based on the understanding of the directive. Directives can be executed, for example, by activating and/or interfacing with any applications, other BOTs, web sites, services that may be available on the device, underlying systems available to MyBOTs.Tv, as well as services available over an electronic network such as an intranet or the internet. In various embodiments, such activation of external functionality can be performed via remote procedure calls, utilizing their API's, or by any other suitable mechanism. In this regard, the Personal Helper BOT systems of various embodiments of the present invention can unify, simplify, classify, organize, and/or rank order tasks for its users and improve the user's experience with respect to many different applications of an electronic device and how it works with the internet but also significantly remove the owner's dependency on the device and its functions by offloading the work to his or her staff of Personal Helper BOTs.

In some embodiments, one entity will have Personal Helper BOTs that interact with the BOTs of another entity and perform transactions—completely autonomously and without intervention from the owners of either of the Personal Helper BOTs who completed the transaction. Users are single entities that may include, for example, children or students, professionals, companies or countries.

Users can thereby be relieved of tasks that they can effectively off load to the Personal Helper BOTs or have the burden of managing and negotiating the on-going learning curve of new applications and deeply, nested but nevertheless needed functionality. In some embodiments, the stored procedures that automate the teamwork activity will have already mastered and simplified the application functionality that would otherwise have been a challenge for the user. In these embodiments, the intelligence encapsulated by the Personal Helper BOTs will involve deep knowledge and understanding of software use case functionality on the device as well as on the web thereby removing not only the complexity as the number of apps scales up, but the need for users to be assisted with it. Supportive studies can be conducted regarding user expectations for functionality and all aspects of these use cases can be automated first to create plug and play Personal Helper BOT services that will be more desirable than loading a complete application unnecessarily.

In addition, in various embodiments, the Personal Helper BOTs of the present invention provide a believable personal assistant in the form of a customizable avatar that the user may find much more socially inviting and more like a companion and/or a real person that they may talk to and simply ask for help. The user can engage in forms of conversational dialogue with the avatar using any of a number of available input and output mechanisms, such as for example speech, gaming interfaces, graphical user interfaces, text entry, car dashboard interfaces and the like. The BOT system can be implemented using any of a number of different platforms, such as device API's, the web, email, gaming interfaces, TV based browsers, digital media receivers, new entertainment enabling operating systems and the like, or any combination thereof.

Requests for additional information required to complete a service request can be presented to the user as a question from the avatar as part of a conversation. Short term memory is engaged by keeping service requests recently executed in local memory of the current session or in a short-term memory cache of a fixed size using for example, a caching scheme. Long term memory can be engaged so that successfully fulfilled service requests are remembered using case-based reasoning (CBR), among other artificial intelligence techniques, recalled, replayed, adapted, and resaved with new indices that can include the user's demographics.

By caching the solutions to past cases, the Personal Helper BOTs system can avoid redundant computation and reuse past solutions to solve new problems. This advantage is most effective when the same user, conditions, and inputs are involved. In these scenarios, the system in the disclosed invention would store the procedures to past collaborations that are similar to the new problem. If the new problem matches a past case, the system retrieves the solution from memory and avoids recomputing it. This approach significantly improves the efficiency of the system, especially as the case base grows larger.

CBR involves not only reusing past solutions but also adapting them to the new problem. This requires a process of case matching and plan modification, where the system identifies past cases that are relevant to the new problem and extracts the relevant features and constraints. The system then adapts the solution from the matched cases to the new problem. The case matching and adaptation process ensures effective problem-solving.

In addition, in various embodiments, the conversational interface between the user and the avatar will grow over time to include words and phrases used to call stored procedures. Those skilled in the art will recognize opportunities to program the elements that coordinate BOT activity in specific ways that satisfy their business, social or otherwise functional requirements.

In various embodiments, the Personal Helper BOT system will fulfill help service requests that take into account how the request by its nature needs to be fulfilled and respond accordingly. For example, it will certainly recognize opportunities to serve its owner by sending useful perhaps critical information at just the right time, send letters on his or her behalf, provide alerts that have been requested and suggest soft alerts based on information it knows about its owner, and injecting events or tasks into the owner's calendar and/or to do list based on schedules that are either fixed or are temporally calculated.

In various embodiments, the system employs external web sites in order to fulfill a service request. According to technology as it exists today, in order to get full functionality out of many web sites providing applications that are not interrelated, it almost always requires the web site user to re-enter his or her information over and over again. The popular use of Personal Helper BOTs will require a paradigm shift in which web sites “BOT enable” themselves. These Personal Helper BOTs will securely carry all of personal information-thus making it possible for one to dock itself at a BOT enabled web site, exchange the necessary information required to complete a transaction, disconnect after having persisted the information at the site or perhaps opting not to do so, then move on. This is far more efficient when one thinks about why fast-food restaurant chains implemented the fast-food drive through function. Do we give McDonalds corporation our name and demographic information then go to McDonalds and say “Hi, you know me already and I would like a hamburger and fries?” Then after this, do we go to Burger King and Wendy's web sites and log our information with them again so we can go there and say “Hi, you know me now, can I have a Whopper or a Frosty please?” The current means for obtaining various services from multiple web sites and constantly authenticating and re-entering information is simply not the most efficient way to set up rapid sales. In a new era when those familiar with latest trends in e-commerce are talking about omni-shopping, we must prepare in anticipation of billions of fast food-like service requests per day. Financial Personal Helper BOTs will potentially have access to an individual's personal and financial information so such an embodiment of such Personal Helper BOT Systems require Security. Part of the power in the BOT API will be the programmable and configurable rules, preferences, security and otherwise, that will govern how the BOT enabled web sites access and utilize this information. For example, a person's inputted personal settings for TV show preferences could certainly also be applied so that person's BOTs could be renting movies or purchasing games if the owner decided to enable that association. BOT enabled web sites will only have access that is provided by the owner. In some embodiments, owners will supply a dollar amount limit up to which a BOT can purchase an item autonomously without telling them and then when finished, simply inform them that an action has been taken.

In some embodiments as well, the generic functions the Personal Helper BOT system uses to provide services to the owner presume device independence. For example, when these embodiments employ additional functionality powered by external services that may be native to the delivery device, the generic functions will have to be instantiated based on the features of the device. That is, the Personal Helper BOT system will be able to detect the device and dispatch the appropriate version of the generic function for that device, such as dialing a telephone number, sending out a formal letter or email, or calling a web service.

In various embodiments, the system of the present invention can be implemented to provide relief in any of a number of different domains. Examples include:
Take your calls and deliver your messages (according to your preferences)
Find you a job and fill out numerous job applications for you.
Screen prospects and find you a mate
Find you entertainment
Create a personal TV guide based on your value preferences.
Create a personal newspaper (your interests, your values)
Pose personal challenges
Track personal goals for weight loss and take your reporting data and makes stats it then presents back to you as a cumulative report later on
Give academic quizzes (and uses your stats to make you better at your weakest areas)
Find news you are likely to be interested in hearing and send it to you.
Push word definitions to you (based on something you have read).
Push inspirational stories or scriptures to you based on something you went through.
Tell you Happy Birthday and remembers your birthday and everyone in your friends or family.
Remembers dates that are sentimental to you and pushes you messages so that you know the BOT is thinking about you or people you care about.
Accumulate Totals on statistics of interest.
Keep Statistics and statuses
Alert you when certain conditions arise
Remind you about your car maintenance schedule
Help keep up with your pet care and maintenance tasks.
Help keep up with schedules for taking medicine or giving medicine to the cared for.
Remind the user about other possessions maintenance schedule (washer dryer TV computer other cars, jewelry etc.)
Work with other BOTs to provide you with a to do list
Find bargains for you (and sends them to you by link or otherwise)
Find Coupons
Suggest ideas related to your interests.
Answer questions (FAQS) about any topic (i.e., hobbies)
Find knowledge or resources and reports it to you.
Fill out and submit job applications with job seeker sites provided that these sites are “BOT-Enabled.”
Manage e-mail 100%.
Maintain social media pages and manage content.

One skilled in the art will recognize that the above list of potential applications or domains is merely exemplary. In addition, the system of the present invention can be implemented in any combination of the following tasks.
Education: Child asks BOT to create a report on volcanoes.
Positively inform: Adult asks BOT to create a newspaper with only “good” news.
BOTs are sent out by a searcher to a network of family members, and then BOT retrieves information from each family member and delivers it back to the searcher.
For example, a BOT could be used to create a family photo album or to use an ancestry site to build the family tree.
Future would be globally impacting like the leading social media sites but it will be . . . “point your BOTs to www.cometomysite.com” then people will send BOTs . . . but the target site must be ready to host the BOTs as well (1) recognize them (2) provide secure data transfer (3) enable BOT to fill out any applications or perform some financial transactions for the user. These will be referred to as “BOT-enabled web sites.”
BOTs should be able to find you a deal, present it to you, and then you say, “Buy it” BOT should be able to do that for you and the next thing is you have the product delivered to you or drop shipped to someone you love.
BOT Security will evolve naturally as did cyber security applications.
Say to Avatar: “Email my sister and tell her she will be ok after the operation” and BOT executes the command.
Say to Avatar: “Write a letter to the bank authorizing permission for my wife to access my account” and BOT executes the command.
Say to Avatar: “Let my ex-wife know that the child support will be arriving after the 18^{th} the month” and BOT executes the command.
Say to Avatar: Global commands to your whole family: “Send a Happy birthday card to everyone in my family birthday” but first alert me so I can choose the card I want to send to them (this will require the card company web site to be “BOT-Enabled”).
Set your BOT up to surprise you with a gift for your birthday.
Financial BOT Services will require the emergence of “BOT Security” services, applications and products.
BOTs will teach people who want to learn.

In a general sense, the present inventive personal helper BOT system would include a user interface (e.g., a display device) electronically connected to as part of the system. The system would also include an electronically connected data input element. A storage element, within and electronically connected to the system, could house one or more data processors (i.e., BOTs). Through the data input element, a user could cause data to be input into the system. Preferably, the data would be recognizable by the system and include the user's intent for the specific service being requested of the system. Also involved would be a library of reusable data processors (i.e., the BOTs) that are selectively appropriated by the system for processing of the inputted data where the BOTS validate, organize, summarize, create abstractions, aggregate, classify, filter, prioritize, calculate, create, the disseminate or otherwise process data. The present inventive system's coordination element, within and electronically connected to the system, further details the collaboration among the BOTs and coordinates their activities. Such coordination element, for example, interprets the inputted data for such BOT(s), synthesizes a procedure in response to the data, translates the data following the synthesis into action steps that invoke the at least one BOT, executes such procedure based upon such translations, and generates at least one response representative of a work of execution procedure of the at least one BOT. An element of this particular embodiment would be a communications element, within and electronically connected to the system, that would communicate at least one such response to the user via, the user interface. Ultimately, the system would learn to do a task autonomously using case-based reasoning artificial intelligence techniques to learn from prior use, thus engaging short term memory and long-term memory to successfully fulfil requests remembered using such case-based reasoning to recall, replay, adapt, and resave with new indices. Accordingly, not only is the complexity of multiple number of operations to be used scale up removed, but there is also a reduction in the need to assist such user in the operation.

More succinctly stated, in its general embodiment, the present invention starts with a computing unit for processing data. A user interface, a storage element for at least one BOT, and a data input element would be preferably electronically connected to the computing unit. The data input element would enable a user to cause data to be input into the system and the data would be recognizable by the computing unit, including the user's intent for the specific service being requested of the system. Additionally, the computing unit would preferably be electronically connected to a library of reusable data capable of processing one or more BOTs. The applicable BOTs would be able to selectively appropriated by the system for processing of the inputted data. As such, the BOT(s) would be able to validate, organize, summarize, create abstractions, aggregate, classify, filtrate, prioritize, calculate data.

Further it would be preferable for a coordination element to be electronically connected to the computing unit. That element would collaborate with others in the system, via one or more BOTs, and coordinate activity such that the coordination element could interpret the inputted data for the applicable BOT(s), synthesizes a procedure in response to the data, translate the data following the synthesis into action steps that invoke the BOT(s), execute such procedure based upon such translation(s), and generate at least one response representative of a work of execution procedure of the BOT(s).

A communications element would also preferably be electronically connected to the computing unit. This element would have the ability to communicate one or more responses to the user via the user interface. With all of the foregoing elements, the BOT system has the ability to learn to do a task autonomously using case based reasoning artificial intelligence techniques based upon prior use of the BOT system, thus engaging short term memory and long term memory to successfully fulfill requests remembered using such case based reasoning—recalling, replaying, adapting, and resaving data with new indices. Accordingly, the system would not only remove complexity as the number of operations to be used to scale up, but also reduce the need to assist such user in the operation.

### Summary of the Invention—Genealogy

In a more specific embodiment of the present invention, for example, one used in genealogical studies, the inventive system be applied to the specific application of assisting users who seek to conduct genealogical research. In this case, in connection with a computing unit, the library includes genealogy BOTs. Such BOTS would perform searches against historical genealogical data stores selectively appropriated by the system for processing of the input search intents. The BOTs would search large volumes of historical records, filter the data to find specific information of interest to the user, and aggregate information of interest to the user disseminated by reports. The system would also include a database management element, a coordination element that would programmatically orchestrate the collaboration among the genealogy BOTs and, as necessary, activity with one or more other BOTs. Such coordination element would therein interpret the user profile data and user intent, synthesize a run-time procedure in response to the user intent, translate the data following the synthesis into action steps that invoke the at least one BOT, execute such procedure based upon such translations, and generate reports for the user representative of a work of execution procedure of the at least one BOT. An avatar interface, within and electronically connected to the system, would be used to communicate at least one such response to the user via, the user interface. The results produced by such a system as described above would be based upon the system learning to do a task autonomously using case-based reasoning artificial intelligence techniques thus leaning from prior genealogical search the intents of the user as the system gains experience processing genealogical searches. Thus, the system would be engaging in short term memory and long-term memory to successfully fulfill requests remembered using such case-based reasoning to recall, replay, adapt, and resave with new indices.

One embodiment of the present invention represents an efficient genealogical research system based on a Helper BOT architecture. The Helper BOT system serves as the entirety of the system, architected to orchestrate the genealogy research process. Specialized BOT classes within the system know how to fetch data when needed, unifying the search procedure. By leveraging restful calls and remote procedure calls to external systems, the system retrieves relevant information and passes it between BOTs for further processing. This orchestrated collaboration optimizes the search process, enhancing efficiency and reducing redundancy.

Genealogical research typically involves searching through a smaller volume of data compared to general internet searches. For instance, a standard Google search processes approximately 100 petabytes (100 million gigabytes) of indexed web pages, while a Wikipedia search scans over 6 million articles. In contrast, genealogy searches focus on ancestral records and family trees, typically consisting of a few gigabytes of data. Mindful of the foregoing, the embodiment of the system herein is optimized for genealogical data and leverages this reduced data volume to provide faster retrieval of relevant information.

### Summary of the Invention—Music Playlist Curation

In still another embodiment of the present inventive system, the system can be applied to assist users seeking to obtain a rank-ordered listing of playlists most likely to play their songs based on intelligent analysis of song metadata. In this particular embodiment, a library includes song analyzer BOTs. These BOTs analyze song metadata by processing the inputted playlist generation intents. For example, the BOTs extract moods from song metadata, organize and process data to generate statistical radar plots, and aggregate information of interest to the user disseminated by reports for the sake of finding the playlists most likely to give the song maximum exposure. A coordination element within the code stack programmatically orchestrates the collaboration among the BOTs and coordinates activity of at least one BOT. As such, the coordination element interprets the user profile data and user intent, synthesizes a run-time procedure in response to the user intent, translates the data following the synthesis into action steps that invoke the at least one BOT, executes such procedure based upon such translations, and generates rank-ordered playlist recommendation reports for users representative of a work of execution procedure of the at least one BOT. As similarly discussed above, the inventive system ultimately learns to do a task autonomously using case-based reasoning artificial intelligence techniques by learning learn from prior playlist generations for various songs as the system gains experience generating ranked order playlist recommendations. Also similarly, the system engages short term memory and long-term memory to successfully fulfill requests remembered using such case-based reasoning to recall, replay, adapt, and resave with new indices.

### BRIEF DESCRIPTION OF THE DRAWINGS

FIG. 100 shows an integrated Personal Helper BOT solution organized into architectural layers.

FIG. 200 is a context diagram identifying external factors and how they are related to the underlying Digital Library Architecture used to power Research BOTs and user-directed searches.

FIG. 300 is a context diagram identifying external factors and how they are related to the YOURSearch filter and search engine.

FIG. 400 is a context diagram identifying external factors and how they are related to MyBOTs.Tv Helper BOT Applications, Products. and Services.

FIG. 500 is the MyBOTs.Tv class diagram showing a representative group of the system's base classes, their attributes, operations (or methods), and the logical relationships among objects.

FIG. 600 is a sequence diagram modeling the programming logic in MyBOTs.TV for the function under the Digital Library Architecture that presents search results as rank order listings in an order most likely to satisfy the user. Personal Helper BOTs utilize this function to deliver BOT services, products and/or applications.

FIG. 700 is a sequence diagram modeling the programming logic in MyBOTs.TV for the function under the Digital Library Architecture that creates physical Digital Library Objects.

FIG. 800 is a sequence diagram modeling the programming logic in MyBOTs.TV for the function under the Digital Library Architecture that creates, activates, and/or deactivates physical Digital Library users.

FIG. 900 is a sequence diagram modeling the programming logic in MyBOTs.TV for the function under the Digital Library Architecture that allows the Librarian actor to induct new elements and metadata into the Digital Library.

FIG. 1000 is a sequence diagram modeling the programming logic in MyBOTs.TV for the function that processes search results, decomposes them and their links or attachments and captures contents with a markup language.

FIG. 1100 is a sequence diagram modeling the programming logic in MyBOTs.TV for the function under the Digital Library Architecture that loads data into Channels (popular filters set up for large sectors of the consumer population).

FIG. 1200 is a sequence diagram modeling the programming logic in MyBOTs.TV for the function that synthesizes document products out of search results and delivers them to the searcher as formatted synthesized documents of various document types.

FIG. 1300 is a sequence diagram modeling the programming logic in MyBOTs.TV for the function under the Display Engine that knows how to display and allow user interaction with all document types.

FIG. 1400 is a sequence diagram modeling the programming logic in MyBOTs.TV for the functions specifically under YOURSearch that decompose search engine results and put them into markup language so that they may be used to construct documents and/or more personalized search products and applications for users.

FIG. 1500 is a sequence diagram modeling the programming logic in MyBOTs.TV for the function that processes inbound service requests and puts them into a queue for processing.

FIG. 1600 is a sequence diagram modeling the programming logic in MyBOTs.TV for the function that processes service requests, prepares and puts responses into a queue for processing and delivery to the user.

FIG. 1700 is a package diagram showing the dependencies between major elements of the Personal Helper BOT System.

FIG. 1800 is a data flow diagram (DFD) showing the “flow” of data through the YOURSearch component of MyBOTS.Tv-modeling its process aspects.

FIG. 1900 is a diagram showing how users require search results that are far more customized to their needs and preferences.

FIG. 2000 is a data flow diagram (DFD) showing the “flow” of data through the YOURSearch component (1800) of MyBOTS.Tv and modeling the delivery of alerts to end users.

FIG. 2100 is a data flow diagram (DFD) showing the “flow” of data through the BOTs component of MyBOTS.Tv, modeling the process of providing BOT Services, Applications, and Products to end users.

FIG. 2200 is a deployment diagram showing the physical deployment of MyBOTs.Tv and the hardware components running on each node and how different pieces are interconnected.

FIG. 2300 deployment diagram models the physical deployment of MyBOTs.Tv and shows how the servers are connected to the inputs and outputs.

FIG. 2400 is a data flow diagram showing the internal components of the underlying Digital Library Architecture.

FIG. 2500 is a use case diagram portraying the users of MyBOTs.Tv and the various ways they interact with the YOURSearch component of the system.

FIG. 2600 is a use case diagram portraying the users of MyBOTs.Tv and the various ways they interact with the BOTs component of the system.

FIG. 2700 is a use case diagram portraying the users of MyBOTs.Tv and the various ways they interact with the process for queueing inbound service requests and assigning BOTs to them.

FIG. 2800 is a use case diagram portraying the users of MyBOTs.Tv and the various ways they process inbound requests and provide outbound responses to users.

FIG. 2900 is a deployment diagram showing the physical deployment of MyBOTs.Tv and how the hardware artifacts are connected and the server farm is segmented by service request type.

FIG. 3000 is a block diagram showing the interaction and connectivity of the hardware components of MyBOTs.TV internal to the servers that process the inbound service request queue.

FIG. 3100 is a block diagram showing the internal components of the CPU processors required for servers of the MyBOTs.Tv Personal Helper BOT System.

FIG. 3200 is a block diagram showing a MyBOTs.Tv Computing Device.

FIG. 3300 is a pictorial depiction of a BOT avatar. FIG. 3600 is the user-avatar interaction wireframe.

FIG. 3400 is a block diagram showing the components of an embodiment of a MyBOTs.Tv Personal Helper BOT System. FIG. 3400A is a block diagram showing the components of an embodiment for music playlist curation. FIG. 3400B is a block diagram showing the components of an embodiment for genealogical research.

FIG. 3500 is a block diagram showing the components of the BOT security operations.

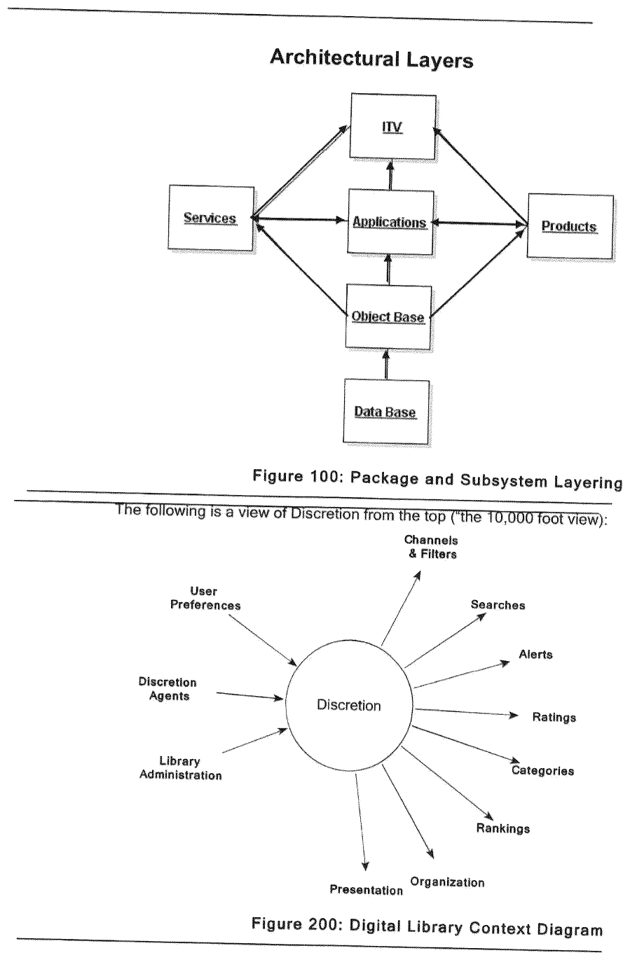

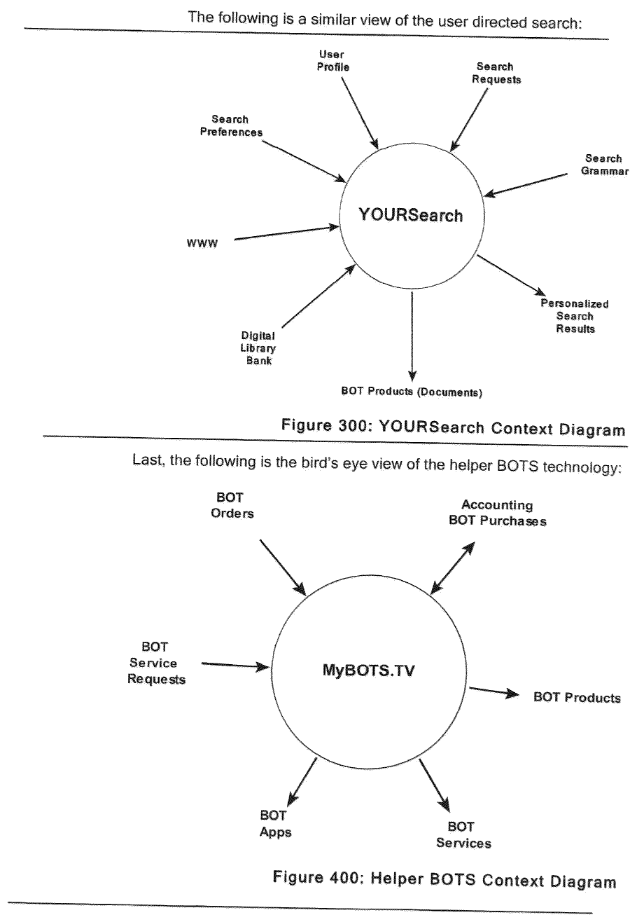

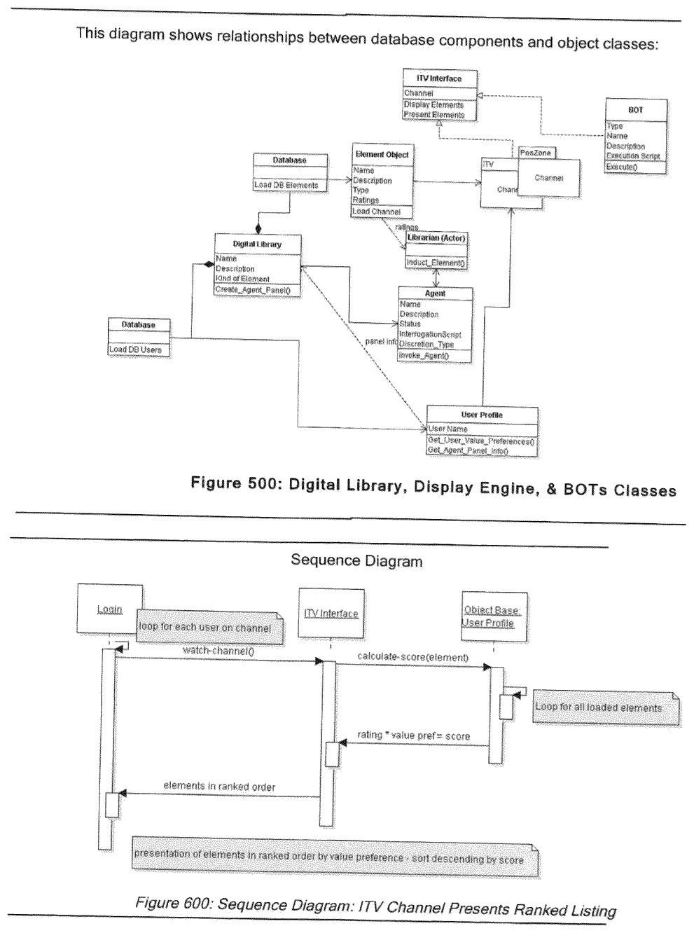

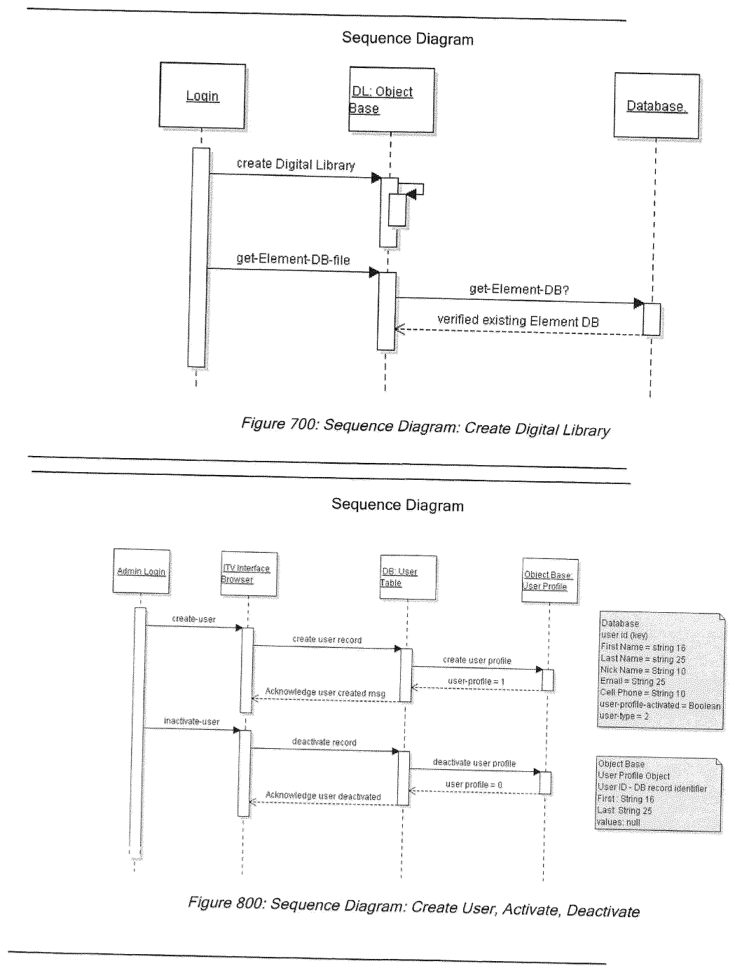

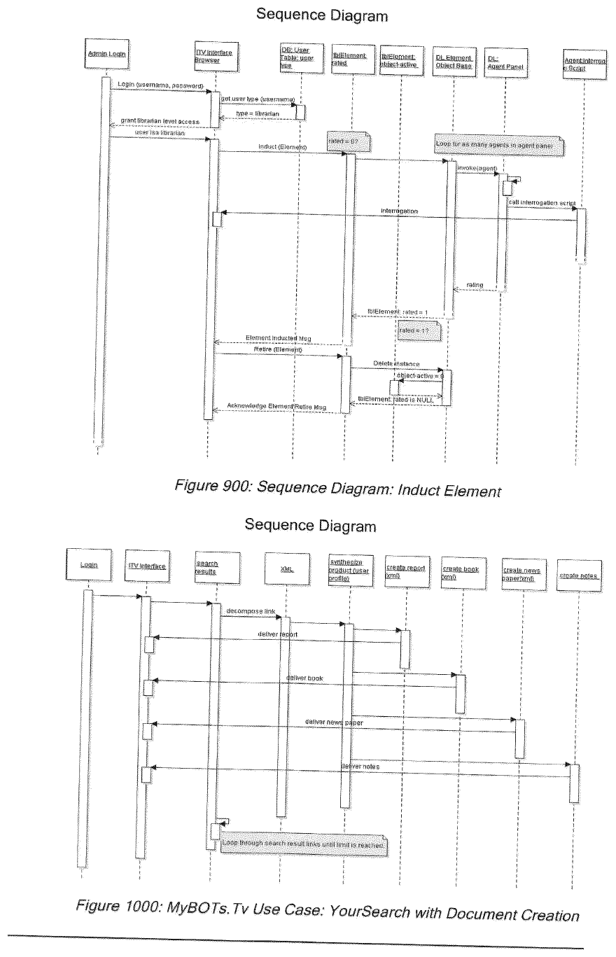

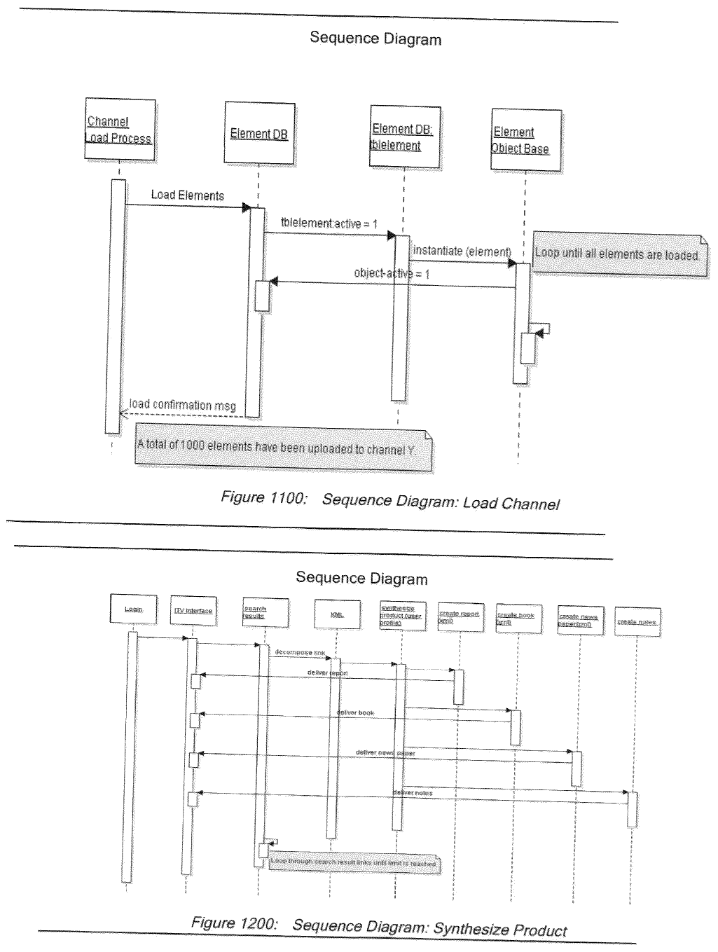

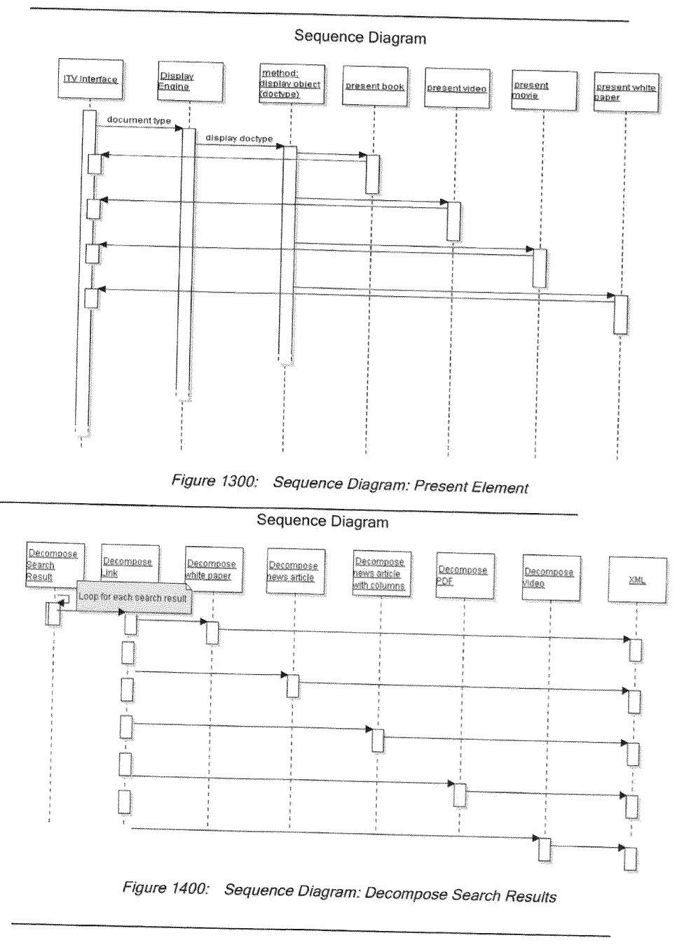

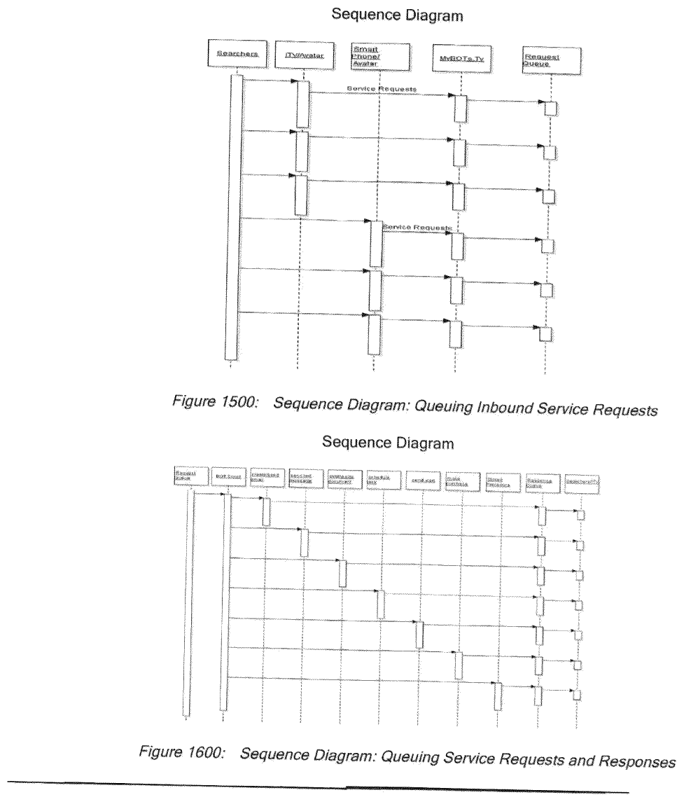

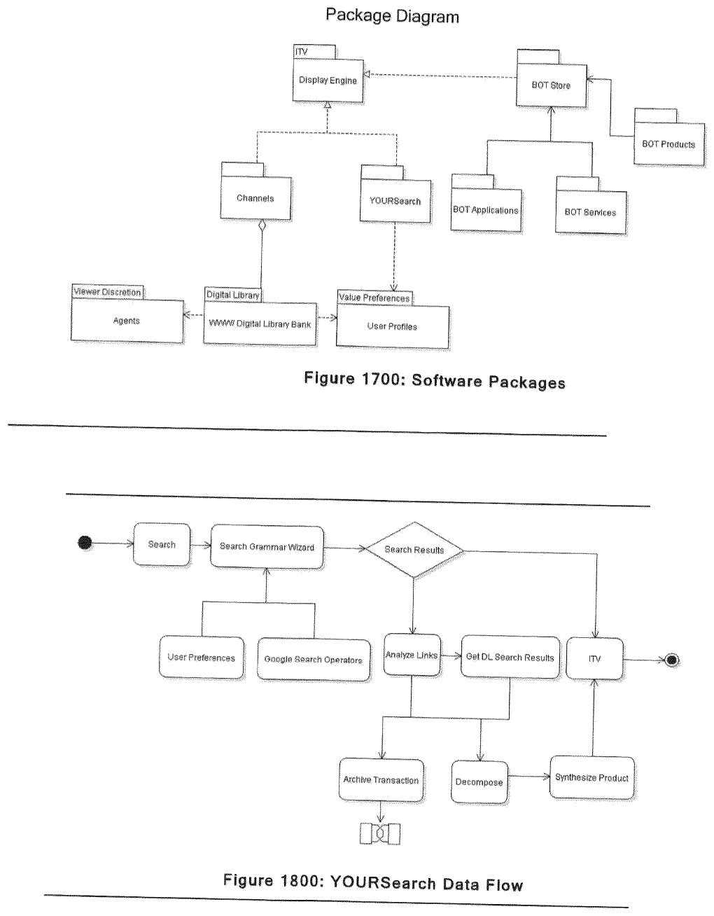

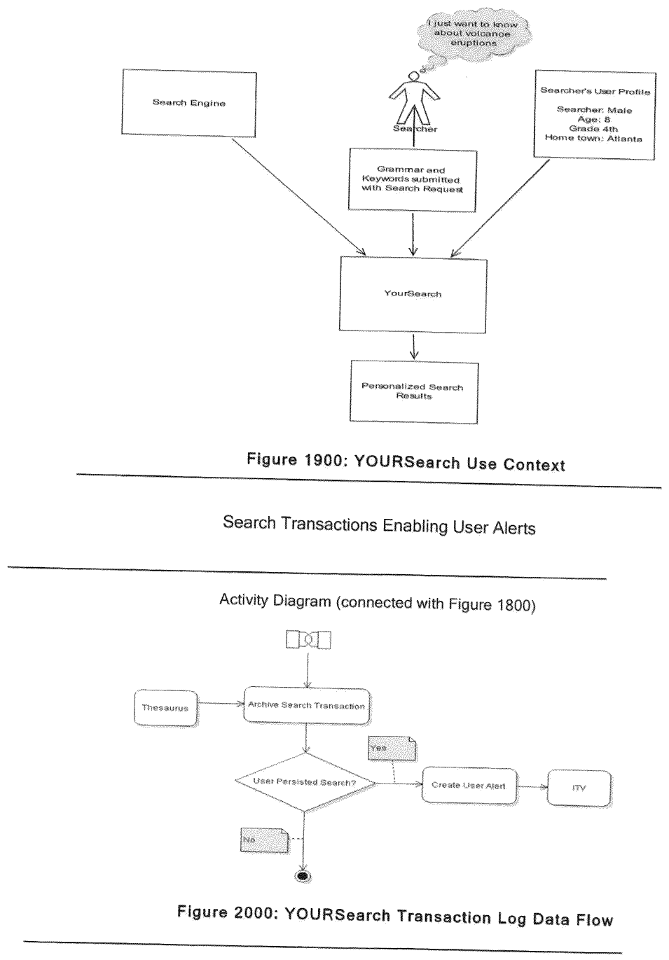

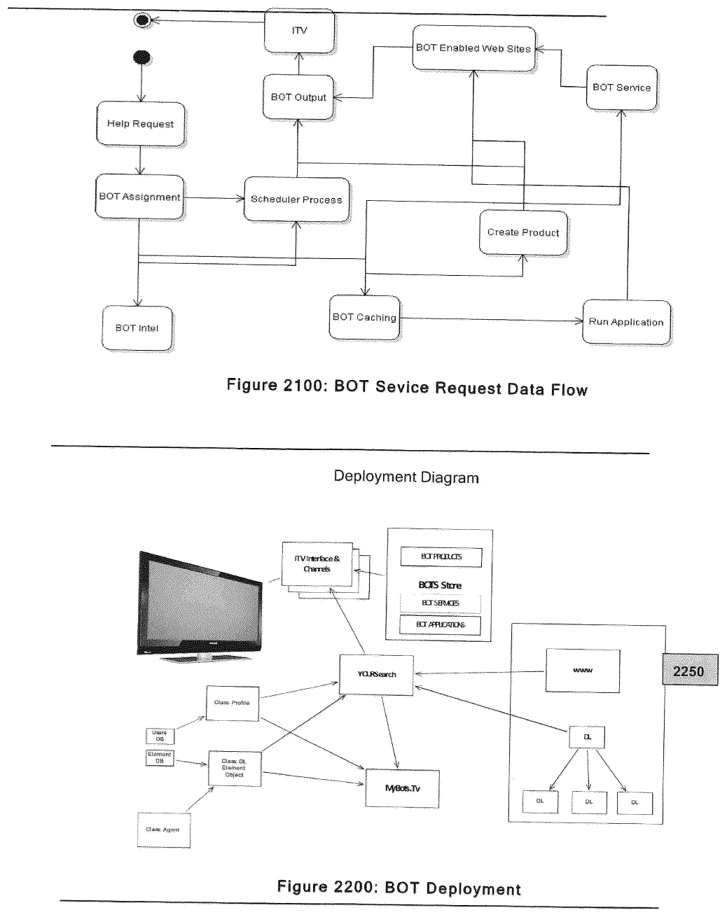

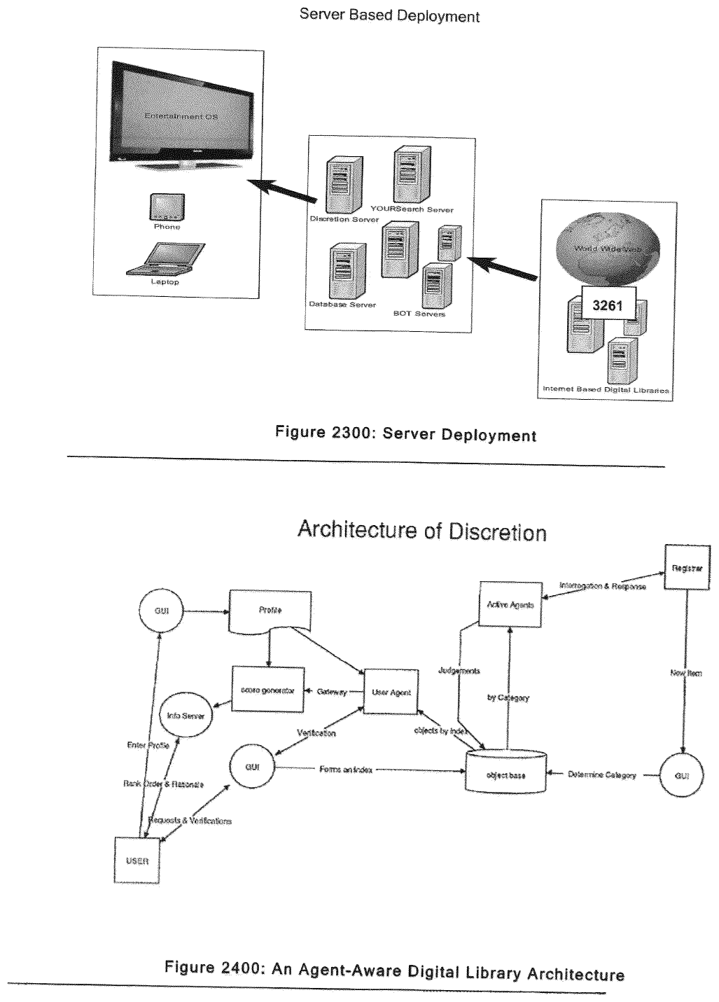

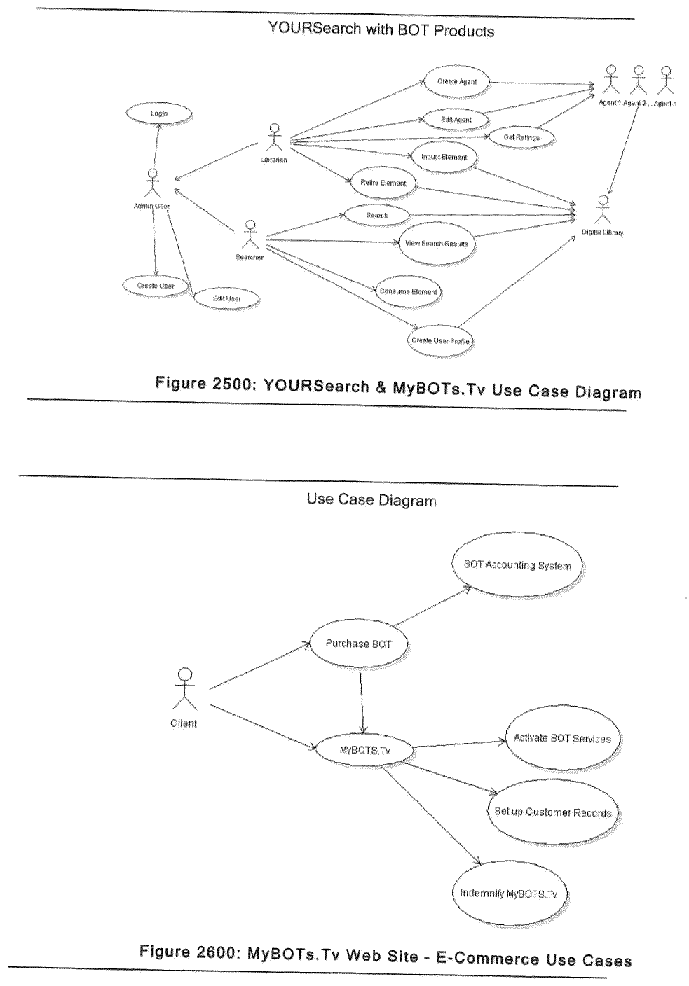

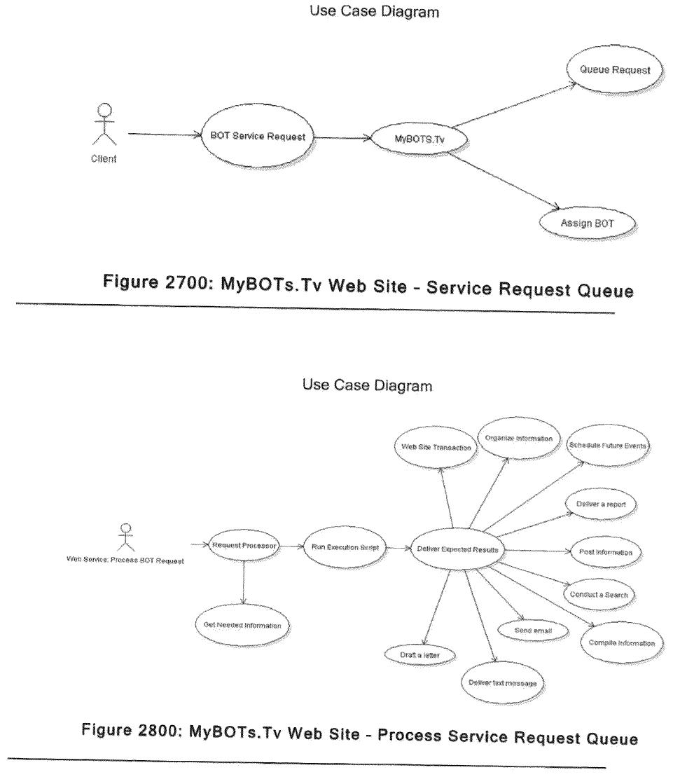

### DETAILED DESCRIPTION OF THE EMBODIMENTS

### Television and Other Devices

Various techniques will now be described in detail while referencing a few example embodiments as illustrated in the accompanying drawings. In the following descriptions, numerous specific details are set forth in order to provide a thorough understanding of one or more aspects and/or features described or referenced herein. It will be apparent, however, to one skilled in the art, that one or more aspects and/or features described or referenced herein may be practiced without some or all of these specific details. In other instances, well known process steps and/or structures have not been described in detail in order to not obscure some of the aspects and/or features described or referenced herein.

One or more different inventions may be described in the present application. Further, for one or more of the invention(s) described herein, numerous embodiments may be described in this patent application, and are presented for illustrative purposes. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, architectural, software, electrical and other changes may be made without departing from the scope of the one or more of the invention(s). Accordingly, those skilled in the an will recognize that one or more of the invention(s) may be practiced with various modifications and alterations. Particular features of one or more of the invention(s) may be described with reference to one or more particular embodiments or figures that form a part of the present disclosure, and in which are shown, by way of illustration. It should be understood, however, that such features are not limited to usage in one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for the sake of the disclosure only and are not to be taken as limiting the disclosure in any way.

A description of an embodiment with several components in communication with each other does not imply that all such components are required. To the contrary, a variety of optional components are described to illustrate the wide variety of possibly embodiments of one or more of the invention(s).

This patent application discloses the four main components of the Personal Helper BOT system, as follows:
1. Discretion—An Agent-Aware Digital Library Architecture provides a base of elements upon which to build the Personal Helper BOT solution. Unlike a database, discretion allows for the concept of a digital library of elements which among other things, stores both static and dynamic metadata about the elements. With metadata accessible, the elements may then be much more discretely served to users in accordance with their preferences.
2. YOURsearch (Your Own User-directed Retrieval)—A suite of next generation search tools and filters that change the internet search paradigm as we know it-bringing us into the next generation where searches are more user-directed, user-architected, personalized services that provide accurate results that directly fulfill our requests.
3. MyBOTs.Tv—An exciting development of helper “BOTs” (software bound robots or autonomous agents) that by understanding who we are, are then able to provide a plethora of new and personalized services, applications and products. YOURsearch works by itself as a search engine alternative but may also leverage BOTs to provide more refined, personalized and customized search results.
4. Interactive TV Interface—An integrated delivery platform that by design, suggests that we upgrade our TV watching experience to include new possibilities. Integration of the kinds of elements we view and interact with, the kinds of experiences we expect, the kinds of educational research we can conduct, the kinds of searches, services and applications we can architect, and with this wealth of integrated information, the kinds of products we can create and market. For once, we seek to unify the delivery platform for consumable entertainment and education providing entities and hope that our American culture gets the hint. BOTs that are in communication with each other need not be in continuous communication with each other, unless expressly specified by way of procedures created with the BOT API and/or the context in which they are used. In addition, BOTs that communicate with each other may communicate directly by messaging or indirectly asynchronously through an intermediary structure such as a blackboard, a cache, a database or a message bus.

Indirect communication and the passing of intermediate results is necessary in embodiments that utilize context switching. This occurs where one BOT begins the execution of a stored procedure, obtains a result and then requires another BOT to perform a task that it depends and waits on, obtains a result, then goes back to its original execution flow.

Each BOT is an object in a BOT class that has at least the following base attributes: name, description, and execution script. The execution script has lines of code that are executed by processors. The lines of code can be operating system commands, programming instructions, messages, remote procedure calls, and/or web service calls, and various embodiments of gets, puts, and fetches—depending upon various embodiments of BOT services, applications, and/or products.

Further, although process steps, method steps, algorithms or the like may be described in a sequential order, such processes, methods, stored procedures and algorithms may be configured or programmed to work in alternate orders. Hence, any sequence or order of steps that may be described in this patent application does not, in and of itself, indicate a hard requirement that the steps be executed in that order. The coordination of steps executed by BOT Teams while executing a team task or the steps performed by a single BOT while processing a customer service request may be performed in any order practical. Some steps may be performed simultaneously and/or in parallel despite being described as occurring sequentially or non-simultaneously. The manner of collaboration of the Personal Helper BOTs is detailed by how these coordination elements organize the steps. Moreover, the illustration of a process by its depiction in the drawings does not imply that the illustrated process is exclusive of other variations, modifications and/or updates. Any changes to the drawings to not imply that the illustration of the process as depicted before the changes are in any way invalidated by the changes.

Although described within the context of Internet BOT technology, it may be understood that the various aspects and techniques described herein may also be deployed and/or applied in other fields of technology such as robotics, intelligent automated assistants, various applications of autonomous agents, or any other involving human and/or computerized interaction with software or complete automation of the function requiring such interaction. Other aspects relating to collaborating teams of software robot technology by the applicants are disclosed in one or more of the following references:
IEEE International Conference on Systems, Man, and Cybernetics, 1997 Citations: (2) An Agent-Aware Digital Library Architecture for Interactive Television
IEEE Computer Society Press. 1993
Paper: A Virtual Knowledge Architecture for Intelligent Robot Planning

### Hardware Architecture

The Personal Helper BOT system disclosed herein may be implemented on hardware or a combination of software and either physical or virtual hardware. For example, they may be implemented in an operating system kernel, a web service, set top box, parallel processing machine, client server system, and or server farms supporting highly trafficked web sites with load balancing, web acceleration and/or SSL termination. In specific embodiments, the architectures disclosed herein may be implemented in software such as an operating system, entertainment operating system or in an application running on the operating systems.

According to specific embodiments, at least some of the features and/or functionalities of the various architectures disclosed herein may be implemented one or more general-purpose network host machines such as end-user desktop computer systems, network or web server, mobile computing device, gaming system, personal digital assistant, mobile phone, smart phone, laptop, tablet computer (or the like), entertainment operating system, consumer electronic device, music player, or any other suitable electronic device, router, switch, or the like, or any combination thereof. In at least some embodiments, part or all of the features and/or functions of the Personal Helper BOT system disclosed herein may be implemented in virtual computing environments. Any such embodiment that implements the functions and features disclosed herein by virtue of virtualized computer systems is also covered by this patent application.

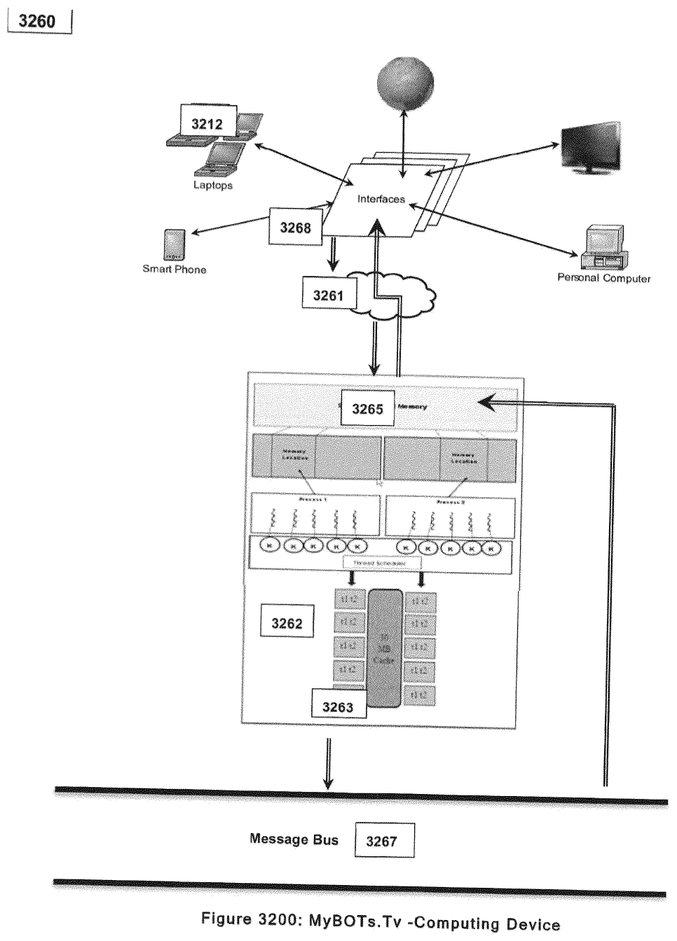

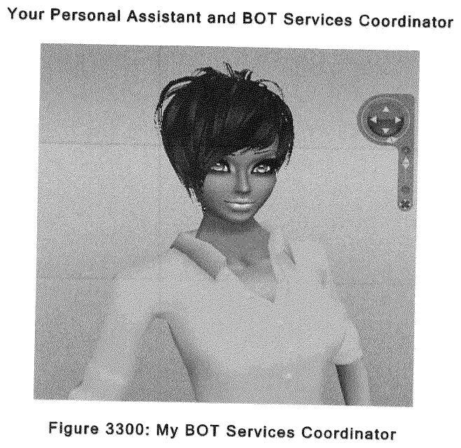

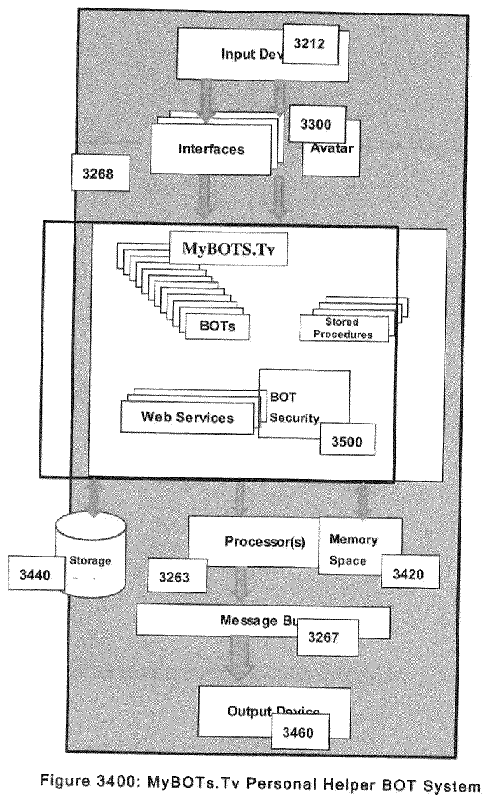

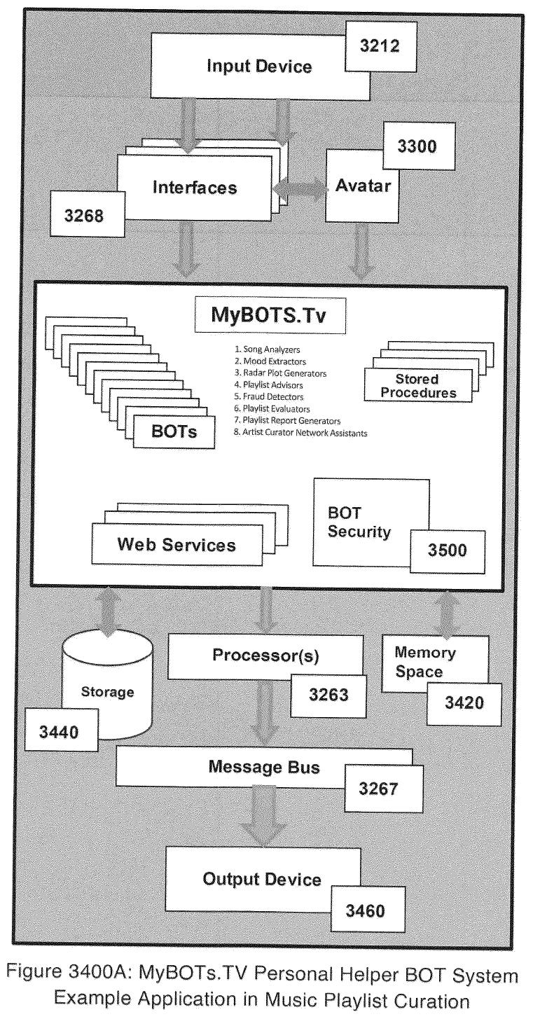

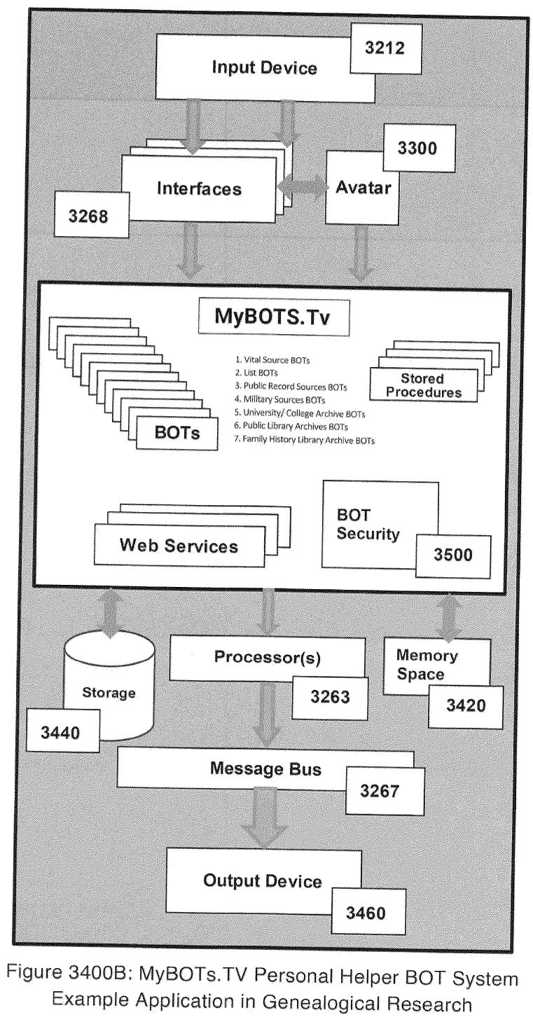

FIG. 3200 is deployment diagram models the physical deployment of MyBOTs.Tv as a computing device that processes input from a variety of sources and interfaces, flows through the Internet and firewall, and is processed by enabling hardware to produce a response for the user.

Refer to FIG. 3200, there is shown a block diagram depicting a computing device 3260 suitable for implementing at least a portion of the Personal Helper BOT system features and/or functionality disclosed herein. Computing device 3260 may be, for example an end-user personal computer system, network server or server system, mobile computing device such as a personal digital assistant, mobile phone, smart phone, laptop, tablet computer, or the like), consumer electronic device, music player, gaming system, or any other suitable electronic device, or any combination or portion thereof. Computing device 3260 may be adapted to communicate with other computing devices, such as clients and/or servers, over a communications network such as the Internet or an Intranet, using known protocols for such communication, whether wireless or wired.

In one embodiment, computing device 3260 includes central processing unit (CPU) 3262 and message bus 3267 (such as an Enterprise Service Bus). When acting under the control of appropriate software or hardware. CPU 3262 may be responsible for implementing specific software functions and/or code written to take advantage of the specifically configured and/or programmed hardware capabilities of a computing device or machine. For example, in at least one embodiment, a user's smart phone may be configured, designed, or programmed to function as a Personal Helper BOT system using CPU 3262. In another embodiment, the helper BOT system software implemented in the server platform will specifically be architected, programmed and/or configured to take full advantage of the multi-threading capabilities of CPU 3262, while still adhering to a Service Oriented Architecture Model.

In this embodiment, the architecture is a model that combines the processing power of parallel computation with the ease of web service usage.

A web service is a service that can be published, located and/or invoked across the web. As service requests come in to MyBOTs.Tv, and the avatar 3300 has activated and parameterized the right BOTs to handle it, software processes create one or more threads to execute a portion of the BOT execution script associated with the process. In order to provide parallel execution, a new thread is first created and started for each web service handling a line of the execution script. In some embodiments, the lines of the BOT execution script can be direct calls to web services. Each thread in turn then executes the indicated function of the web service with its input parameters.

In another embodiment of the same architecture, processes may be deployed at the level of the execution lines within the BOT execution scripts. This architectural strategy would potentially optimize performance by giving the operating system threads the ability to find available virtual processors after successfully executing each line-thereby avoiding latency associated with threads waiting to execute because they are dependent on the output of another thread within the process.

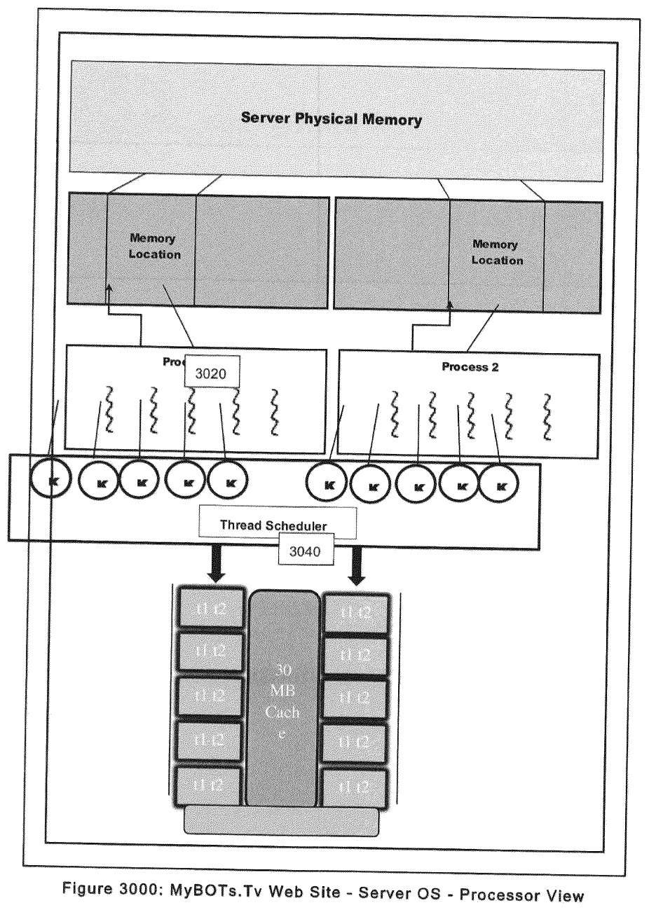

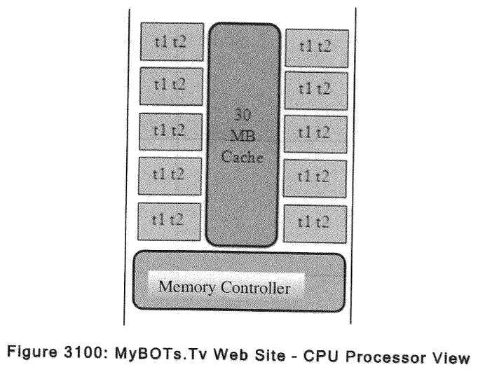

Referring to FIG. 3000, there is a diagram showing what for at least one embodiment of the Personal Helper BOT system, the internal processing flow within one server in a distributed computer network will look like.

3020 depicts a software process that is dedicated to processing of at least one server request. In one embodiment, each of the individual lines of instruction in each BOT execution script is presented to a user thread in the Server's Operating System. For the sake of the practice disclosed herein, a one-to-one mapping of user threads to OS threads is shown. However, the architecture is by no means limited to the one-to-one mapping and will consider one to many, many to many, or any suitable mappings as other embodiments of the hardware architecture. Based on the one-to-one mapping in this embodiment, each user thread hands the task over to one Operating System Kernel thread (depicted by the circles with K).

Fulfilling a Multi-Threading model, each OS thread processes at least one line of the BOT execution script and is submitted to the thread scheduler 3040 when ready for further processing by a CPU core. Thread scheduler 3040 takes this processor request and fulfills it by passing the task to the processor that is ready and available.

CPU 3262 (also depicted in 3100) may include one or more processor(s) 3263 such as, for example, a processor from the Motorola or Intel family of microprocessors or the MIPS family of microprocessors which feature Hyper Threading Technology (HTT). These core processors have the ability to execute 2 threads simultaneously while each shares core processor resources. When such a CPU is used that has multiple cores, the Operating system thread scheduler will see this as 20 virtual processors if there are 10 cores in the CPU. Hence, the OS kernel thread scheduler will pass execution line to the virtual processor that is available to process next.

In some embodiments, processor(s) 3263 may include specially designed hardware (e.g., application-specific integrated circuits (ASICs), electrically erasable programmable read-only memories (EEPROMs), field-programmable gate arrays (FPGAs), and the like) for controlling the operations of computing device 3260, in a specific embodiment, a memory 3261 (such as non-volatile random-access memory (RAM) and/or read-only memory (ROM)) also forms part of CPU 3262. However, there are many different ways in which memory may be coupled to the system. Memory block 3265 or any additional add-on memory space 3420 may be used for a variety of purposes such as, for example, caching and/or storing data, maintaining global variables, storing client settings, intermediate results, programming instructions, and the like.

As used herein, the term “processor” is not limited merely to those integrated circuits referred to in the art as a processor, but broadly refers to a microcontroller, a microcomputer, a programmable logic controller, an application-specific integrated circuit, and any other programmable circuit.

Interfaces 3268 are the devices handling all input to the Personal Helper BOT system. Generally, they control the sending and receiving of data packets over a computing network and sometimes support other peripherals used with computing device 3260. Among the interfaces that may be provided are cable interfaces, frame relay interfaces, Ethernet interfaces, token ring interfaces. DSL interfaces, and the like. In addition, various types of interfaces may be provided such as, for example, Bluetooth™, Serial, Firewire, universal serial bus (USB), Ethernet, PCI, parallel, radio frequency (RF), near-field communications/magnetics, TCP/IP, WiFi, frame relay, ISDN, fast Ethernet interfaces. Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 3268 may include ports appropriate for communication with the appropriate media. In some cases, they may also include an independent processor and, in some instances, volatile and/or nonvolatile memory (e.g., RAM).

Although the system shown in FIG. 3200 illustrates one specific architecture for a computing device 3260 for implementing the techniques of the invention, its embodiments and/or applications described herein, it is by no means the only device architecture on which at least a portion of the features and techniques described herein may be implemented. For example, architectures having one or any number of processors 3263 can be used, and such processors 3263 can be present in a single device or distributed among any number of devices. In one embodiment, a single processor 3263 handles communications as well as routing computations. In various embodiments, different types of Personal Helper BOT features and/or functionalities may be implemented in a Personal Helper BOT system which includes a client device such as a personal digital assistant (PDA) or smart phone running client software, and server system s).

Regardless of network device configuration, the system of the present invention may employ one or more memories or memory modules (such as, for example, memory block 3420) configured to store data, program instructions for the general-purpose network operations and/or other information relating to the functionality of the Personal Helper BOT system and/or techniques described herein. The program instructions may control the operation of an operating system and/or one or more applications, for example. The memory or memories may also be configured to store data structures, cases, keyword taxonomy information, user profile information, search element metadata, advertisement information, user click and impression information, and/or other specific non-program information described herein.

Since such information and program instructions may be employed to implement the systems/methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape: optical media such as CD-ROM disks; magneto-optical media such as floptical disks, and hardware devices that are specially configured to store and perform program instructions, such as read-only memory devices (ROM), flash memory, memristor memory, random access memory (RAM), and the like. Examples of program instructions include both machine code, such as produced by a compiler, and files containing higher level code that may be executed by the computer using an interpreter.

In one embodiment, the system of the present invention is implemented on a standalone computing system. Referring now to FIG. 3200, there is shown a block diagram depicting an architecture for implementing at least a portion of a Personal Helper BOT system standalone computing system, according to at least one embodiment. Computing device 3260 includes processor(s) 3263 which run software for implementing the Personal Helper BOT system 3400. Input devices 3212 can be of any type suitable for receiving user input to the interfaces in 3268, including for example a keyboard, touch screen, microphone (for voice input), mouse, touchpad, trackball, five-way switch, joystick, gaming system controller, and/or any, combination thereof. Output device 3460 can be a screen, speaker, printer, and/or any combination thereof. Memory 3420 can be random-access memory having a structure and architecture as are known in the art, for use by processors 3263 in the course of running software. Storage device 3460 can be any magnetic, optical, and/or electrical storage device for storage of data in digital form; examples include flash memory, magnetic hard drive, CD-ROM and/or the like.

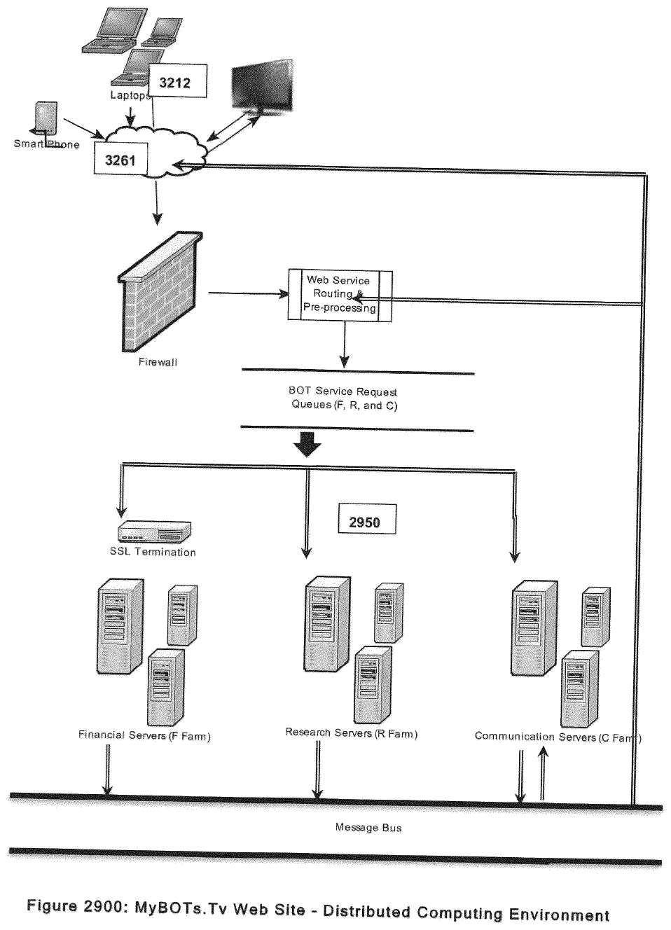

In another embodiment, the system of the present invention is implemented on a distributed computing network, such as one having any number of clients and/or servers. Referring now to FIG. 2900, there is shown a block diagram depicting a service-oriented architecture for implementing at least a portion of a Personal Helper BOT system on a distributed network, according to at least one embodiment.

In the arrangement shown in FIG. 2900, any number of clients providing input via 3212 is anticipated. Each client may run software for implementing client-side portions of the present invention. In addition, any number of servers, 2950 can be provided for handling requests received from clients providing these inputs. Clients providing inputs 3212 and servers 2950 can communicate with one another via electronic network 3261, such as the Internet. Network 3261 may be implemented using any known network protocols, including for example wired and/or wireless protocols.

In addition, in one embodiment, servers 2950 can call external services 2250 when needed to obtain additional information or refer to stored data concerning previous interactions with particular users. Communications with external services 2250 can take place, for example, via network 3261. In various embodiments, external services 2250 include web-enabled services and/or functionality related to or installed on the hardware device itself. For example, in an embodiment where Personal Helper BOT system 3260 is implemented on a smart phone or other electronic device, the Personal Helper BOT system can obtain information stored in a calendar application, contacts, and/or other sources.

In various embodiments, the Personal Helper BOT system 3260 can control many features and operations of the device upon which it is installed. For example, a Personal Helper BOT system 3260 can call external services 2250 that interface with functionality and applications on a device via APIs or by other means, to perform functions and operations that might otherwise be initiated using a conventional user interface on the device. Such functions and operations may include, for example, setting an alarm, making a telephone call, updating a reminder app or to-do list, sending a text message or email message, adding a calendar event, and the like. Such functions and operations may be performed as add-on functions in the context of a conversational dialog between a user and the Personal Helper BOT system by way of the avatar 3300. Such functions and operations can be specified by the user in the context of such a dialog, or they may be automatically performed based on the context of the dialog. One skilled in the art will recognize that the Personal Helper BOT system 3260 can thereby be used as a control mechanism for initiating and controlling various operations on the electronic device, which may be used as an alternative to conventional mechanisms such as buttons or GUIs.

For example, the user may input a user directive to Personal Helper BOT system 3400 such as “I need to have some 6^{th} grade level content put together for my son so he can do a report on volcanoes.”

Once the Personal Helper BOT system 3400 is engaged and the avatar understands the user's directive, the Personal Helper BOT system 3400 can for example, call the ResearchIT BOT with a call to the YourSearch Web Service and parameters having to do with the son's demographics. YourSearch may either enlist external services or may find a solution case in the search transaction database archives of long-term memory, retrieve it adapt it and then re-use it. The BOT will then deliver search results suitable for a 6^{th} grader in the form of a neatly formatted notebook consisting of relevant facts, illustrations and/or media elements about volcanoes. The son may take the artifact that his Personal Helper BOT system provided and use it to create his report. If the service request is ambiguous or in need of further clarification, the avatar will ask for the request again and request that you input the user directive more clearly. The avatar will also attempt to paraphrase your request so user will understand what the avatar believes is his/her request. Upon proper interpretation of the request, the right combination of BOTs and/or external services 2250 will be invoked. When results are obtained after completing execution of a service request or a stored procedure, they are output to the message bus 3267 and prepared for delivery to the client.

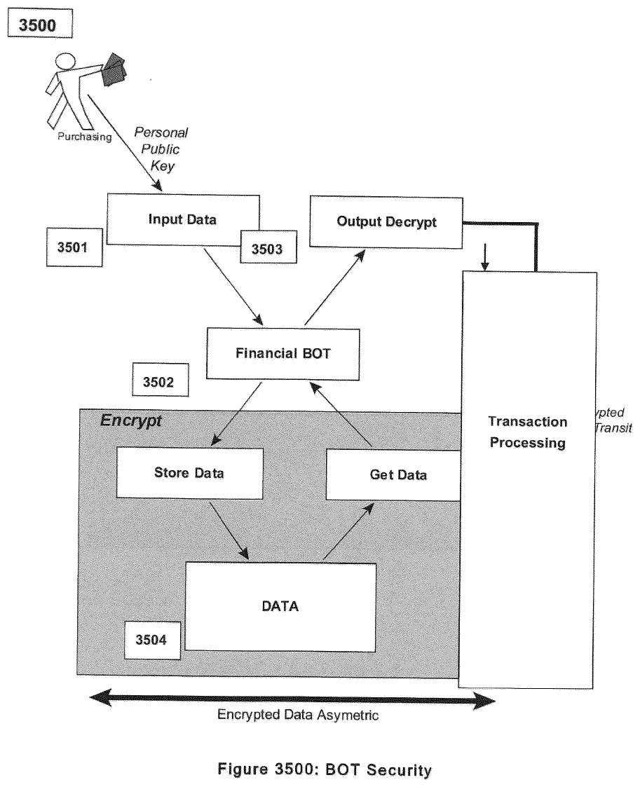

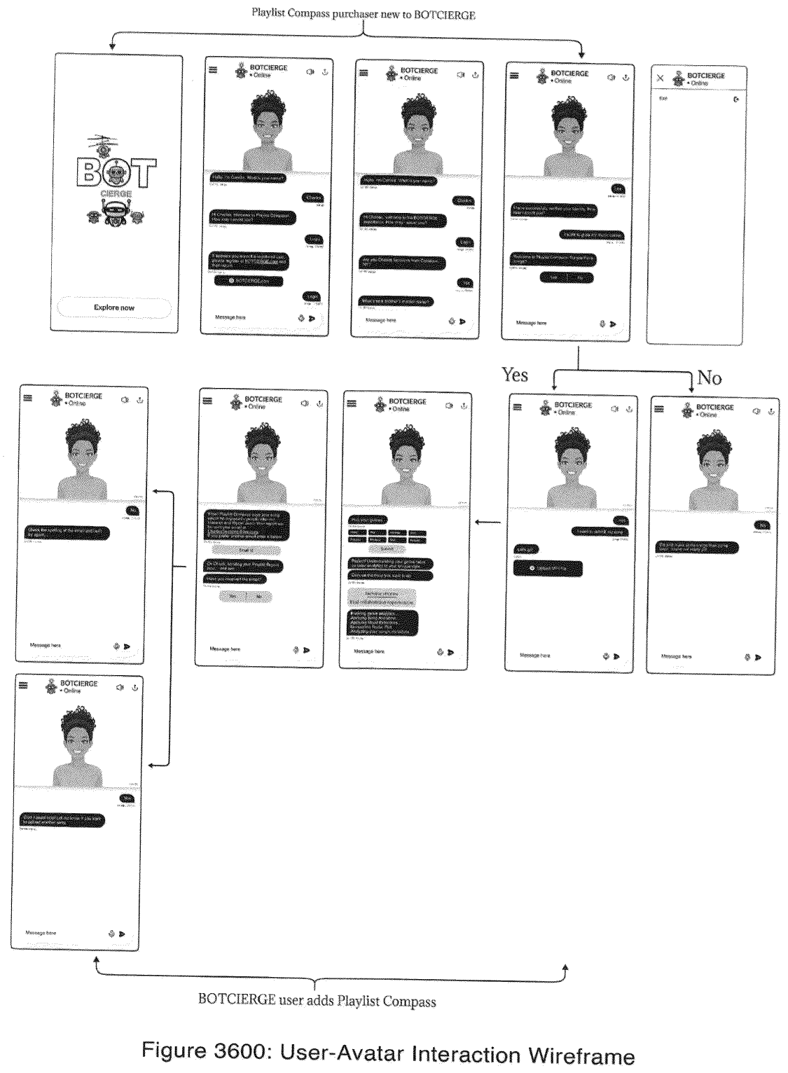

In some embodiments, financial transactions are securely handled by Financial BOTS. Referring to FIG. 3500, there is shown a block diagram depicting a Security Model 3500 suitable for implementing at least a portion of the BOT Security system. The security model adheres to the X.509 ITU-T standard for a public key infrastructure (PKI) and Privilege Management Infrastructure (PMI). The standard fulfills Personal Helper BOT Security Requirements in that it provides, amongst other things, standard formats for public key certificates, certificate revocation lists, attribute certificates, and a certification path validation algorithm.

In 3501 BOT Security will encrypt a transaction with the transaction requester's private key and the target transaction service's public key and submit the request to the BOT security service. A smart tunnel is formed between the requesting BOT and the BOT enabled web service. An X.509 mutual encrypted tunnel is established in which the user is required to authenticate the communication channel before being granted access to a TCP-IP connection.

In 3502 upon receipt of the request in this example of BOT Security-Financial BOT will decrypt the message with its trusted service private key and verify that the public key in the message sent matches the public key and account id stored in the database in 3504 for the encrypted request if it matches the decrypted request message will be stored temporarily in memory 3503 and utilized to begin processing of the request and steps in the requested transaction on behalf of the requester. After the transaction is complete the temporary memory in 3503 will be destroyed and the results of the transaction returned to the requester.

A BOT has intrinsic characteristics (What it is. What is can do, Where it lives and Which service it is associated with). An avatar issues a request to BOTs that its owner has subscribed to. The BOT must be given specific (permissions) signed by the owner of the avatar (Entitlements). For example, the owner subscribes to BOT service BANK OF AMERICA. BOT service assigned to its avatar as part of the instantiation of this BOT subscription. The owner will first be requested to enter their PIN or Fingerprint to show ownership of their x.509 Certificate then the process of entitlements will be started the owner will then set entitlement criterion. The following are examples of Entitlements:
Allowed to transfer up to $1,000 within the us and a certain list of accounts.
Automatic review my accounts activities and notify me if BOT security identifies and fraudulent activity

For data being stored on-behalf of the owner's financial BOT the data will be encrypted with its misted service private key and its public key on behalf of the transaction owner and stored on storage devices 3440. Part of the data stored for BOT Security includes the rights or Entitlements themselves. Such entitlements are available for add/edit via an interface that is provided to the user by BOT security but which is only available to the user once authenticated and working within a secure environment.

BOT Security Entitlements can refer to right to access restrictions upon users with regard to what data or functions they access and/or what they want to protect, where they may want to have the protection applied, and/or when this protection begins. Entitlements may also apply to the pieces of information themselves with respect to the level of security that is applied to that piece of information. Each user will require authentication even to gain access to their personal avatar.

In at least one embodiment. Personal Helper BOTs are called and after execution of their script, deliver results that represent input to another BOT that is then called afterwards. This loop can go on for as long as necessary to execute the main service request and/or stored procedure. In at least one embodiment, BOTs are called and after execution of their script and/or a stored procedure the result array is captured and stored in a storage device for recall at a later time by a similar request for service initiated by either the same or different user. Storage devices can in at least one embodiment, include database tables, but results can also be stored for later recall from short term and long-term memory modules internal to 3420.

FIG. 3600 illustrates a wireframed rendition of the embodiment of the present invention for music playlist curation. Shown is the interaction process between the user and an avatar designed to provide the specified services based on the user's communicated intent.

For one or more of the invention(s) described herein, the following BOT embodiments are described in this patent application, and are presented for illustrative purposes. The described embodiments are not intended to be limiting in any sense. One or more of the Personal Helper BOTs listed here may be widely applicable to numerous embodiments, as is readily apparent from the disclosure. These embodiments are described in sufficient detail to enable those skilled in the art to practice one or more of the BOT invention(s), and it is to be understood that other embodiments may be utilized and that structural, logical, architectural, software, electrical and other changes may be made without departing from the scope of the one or more of these Personal Helper BOT invention(s). Accordingly, those skilled in the art will recognize that one or more of the following BOT invention(s) may be practiced with various modifications and alterations. It should be clear that features are not limited to usage in one or more particular BOT embodiments or figures with reference to which they are described. The following disclosure of BOT embodiments discovered to date is neither a literal description of all BOT embodiments, of one or more of the BOT invention(s) nor a listing of features of one or more of the BOT invention(s) that must be present in all BOT embodiments:

### The 12 “EmBOTiments”

Millions of Personal Helper BOTs will evolve overtime for purposes we cannot even begin to imagine. As the inventor of the Personal Helper BOT, I enthusiastically present the first twelve.

### ToDoList

The ToDoList BOT will tell you the things you need to do on any given day. It will maintain your calendar and keep track of everyday activities. It will not require you to interact with a calendar app rather it will just talk to you—sometimes by messaging, other by way of your avatar. It will communicate with other BOTs whom will in turn supply additional action items that have to be done. In so doing, it acts as the technical coordinator that runs the main script and calls to other BOTs for assistance when needed. This BOT will also show items that have been done for you by your BOT team.

### Thoughtful

The Thoughtful BOT will know about all the people you care about and their favorite things that they like, their interests, and that which makes them happy.

### EventIntel

The EventIntel BOT will know about all significant dates for all the people that you care about birthdays, anniversaries, Christmas, Mother's Day. Father's Day, etc.

### BuyIT

The Buyit BOT will know how to complete a purchase transaction on behalf of one of our clients. It will be able to find and purchase items online like people do. It will know about the dollar limits up to which it may purchase an item as opposed to sending an alert to our client that it has found an item of interest. This BOT will know your financial information and so we will need BOT Security.

### ResearchIT

The ResearchIT BOT will know how to search for information about a topic using the web and digital libraries. This BOT will know how to use the features of YOURSearch to ensure that the results it provides will satisfy user preferences.

### DocumentIT

The DocumentIT BOT will know how to package and deliver information in a document format and style of interest. This BOT will know about all the different types of documents and deliver information in the form of document products.

### Scan&OrganizeIT

The Scan&OrganizeIT BOT will know how to wait for and accept a scanned document, then identify what it is, and file it according to how you have taught it to organize your information.

### GroceryList

The GroceryList BOT (or ToBuyList BOT) will remember your “grocery” list (or list of any items you are about to purchase) and allow you to manage it by adding and deleting line items and quantities. It will also know how to go to store web sites and find digital coupons for items you have already committed to purchasing and save you money by delivering them to your smart phone right at the point of sale!

### ScheduleIT

The ScheduleIT BOT will monitor your schedule and email and manage your appointments and mail inboxes/outboxes by interacting with you and following guidelines you provide.

### ServiceIT

The ServiceIT BOT will know about all your car maintenance schedule, your appliances, your computer hardware, and any purchased goods for which a well-kept maintenance schedule ensures a longer life of usefulness for our clients. All of these maintenance schedules will be kept in one place and your ServiceIT BOT will alert you ahead of time either directly by texting you, by way of your personal avatar, or by putting an action item on your to do list by sending a message to the ToDoListBOT.

### ExpenseIntel

The ExpenseIntel BOT will give you global access to the data behind all of your monthly expenses. It will know how much you spent each month on gas, heat, electricity, water, and any utility of interest. In addition, it will know and understand the usage statistics and calculations that produce the bills. It will respond to questions about consumption, last 6-month average, month by month comparisons and the like. For example, if our clients want to analyze their bill before and after putting in central air conditioning, this BOT will enable that task to become much easier.

### GraphIT

The GraphIT BOT will use the Show Chart Method in the Display Engine to show charts about analyses of interest to our clients. For example, the GraphIT BOT will team up with the ExpenseIntel BOT to produce graphs that depict these analyses. In our last example, where our client wanted to compare the electricity consumption before and after installing central air, the ExpenseIntel BOT will gather the information (from BOT-enabled utility company web sites) and feed it to GraphIT BOT. The GraphIT BOT will in turn process the data on a nice chart with color and the display engine will put it on your big screen TV, smart phone, or laptop/personal computer.

### The Next BOT Generation . . . to Date

Beyond the first 12 BOT Embodiments, the following have likewise been discovered:

### Social Media Manager BOTs

This BOT will maintain your Facebook. Twitter or any social media page for you.

### Medicine Manager BOT

This BOT will help a client remember when to take medicine—and can also help a parent to remember their child's medicine schedule as well.

### Email Manager BOT

This BOT will make sure your email is kept clean and that your rules are followed for where you want email classified.

### Pet Maintenance BOT

This BOT will help you schedule your water changes for fish tanks, your shots for your puppy, remind you to clean the cage for your bird, etc.

### Snippet BOT

This BOT is aware of digital programs inducted into the digital library at the program level but is also aware of snippets within these digital entities that can be directly indexed and inducted in their own right. For example, there could be a digital library element that is a show about Travel and vacation spots. At the program level, the underlying DL architecture will already serve these to consumers in ranked order by classification or preference. The snippet BOT, however, will know the SMPTE code beginning and ending markers for segments within shows so if the Travel program had a segment on Jamaica, snippet BOT will identify this snippet uniquely and pass it to the Librarian in the DL architecture for induction as a library element in its own right. After this, this snippet can be retrieved or served to people looking for information on “Jamaica.”

### Market Research BOT

This BOT enables profiles to be formed for searchers based on their search transactions. This BOT identifies opportunities to market BOT products or services to users that are likely to be interested in them.

In a particular embodiment of the present invention, the synthesis uses a previously captured procedure modified based upon the new data. In a configure that interacts with a video displaying device and interoperable with external functionality via remote procedure calls, and utilization of APIs, the present invention would preferably have a user interface comprising a personal assistant in the form of a customizable avatar and an authentication element within and electronically connected to the computing unit that can confirm the user's identity. Additionally, a receptor, within and electronically connected to the computing unit, would be able to preferably receive results of a search by the BOT(s) based upon data caused to be the inputted data by the user previously. The system would preferably actively elicit service requests from a user, interpret user directives, disambiguate among competing directives, request, and receive clarifying directives or canceling directives as needed, and carry out or initiate service requests based on the understanding of the directive.

In other embodiments of the present invention, the library would preferably be comprised of a digital architecture, a user-directed search filter, and security architecture. Such a digital library architecture would preferably be interoperable with a repository of digital documents and would help the user plan activities associated with the consumption of the documents and wherein the communications element could generate at least one response to the user, and the response(s) would entail the work execution of at the BOT(s). The resulting work would entail the service of organizing documents for consumption in a manner consistent with inputted data from the user.

A preferable storing element comprises of a library of searchable elements of possible interest to at least one user, wherein such elements can be ranked within categories according to the likelihood that at least one user will find at least one element of interest. Additionally, or conversely, an embodiment of the present invention could further comprise a user-directed search filter, wherein the system processes inputted data that directly includes directives incorporating search criteria to execute scripts that coordinate the applicable BOT(s) performs search functions, and wherein the search functions comprise search algorithms. Alternatively, the system could electronically connect to an external search engine.

In still a further embodiment of the present invention, a security architecture is incorporated, wherein the coordination element synthesizes a procedure for authenticating the user.

As a method, the present invention includes the steps of (A) receiving data through a user interface engageable via a device; (B) converting such data into a form recognizable by at least one BOT; (C) coordinating the activity of at least one such BOT, wherein such coordination includes steps of interpreting such data by the at least one such BOT, synthesizing at least one procedure in response to such data, translating such data following the synthesis into action steps that invoke the at least one BOT, executing such procedure based upon such translations, and generating at least one response to such device representative of a work of at least one BOT; (D) communicating at least one such response to the user via the user interface; and (E) learning to do a task autonomously in the performance of the foregoing steps using case-based reasoning artificial intelligence techniques to learn from prior activities, thus engaging system short term memory and long-term memory to successfully fulfil requests remembered using such case-based reasoning to recall, replay, adapt, and resave with new indices, removing the complexity of operation as the number of applications to be used scale up.

### Genealogy Research

The genealogical research question usually revolves around:
Identity: Names and relationships
Gender
Status or events: Births, marriages, and deaths

Genealogists use a variety of methods and genealogical sources to conduct their research, including oral histories, historical records (such as immigration records from Ellis Island), obituaries, census records, naturalization records, probate records military records, birth indexes, birth certificates death indexes death certificates marriage indexes marriage certificates, DNA. A source is a record used for locating information.

Effective genealogy research is built on a variety of sources.
An original source, the first format a source ever took
A derivative source created from the original, but modified in some way, like an index, transcript, translation, or abstract (summary) of the original.
Derivative sources—There are times when derivative sources and authored works expand our understanding of a record. An index may help us see at a glance that several relatives from the same extended family appear in a record set. A translation, however imperfect, may get us closer to understanding the text than we would get on our own. And an authored work may be well-reasoned and packed with cited information we want to know. At the very least, it may contain some fascinating historical context.

In one embodiment of the present invention, the system functions as a source expert. As such, it identifies, extracts, and generates links for itself, including a source's location and list of content. This data is held in a digital repository: for all original and derivative sources in any generation born between 1565-1950, whether the sources are online or located at brick-and-mortar addresses.

As an expert, the inventive system autonomously monitors all newly released genealogical records that are announced. Depending on the newly added source content, it searches for additional answers to the user's research question. Since the inventive system is a Personal Helper BOT System, the search questions are inputted as user directives to the system as service requests or intents.

### Reusable Stored Procedures are Collaborations Among Helper BOTs

For all geographical locations (e.g., 50 states and Washington D.C.) inputted by a research question, the inventive system here is an expert on what sources (original or derivative) exist.

The Personal Helper BOTs of this the inventive system working in collaboration with the source expert have foreknowledge of what sources exist in any geographical location (inputted by the research question, user directive or intent). This step eliminates or includes sources to consult for answers to the research question.

Not limited to extracting, saving and reusing: When were sources recorded (i.e., what year did a state, county, city/town begin to record records of its citizenry?); what sources no longer exist due to burning counties, wars, natural disasters or due to changes in the authority responsible?, record sources may move due to changing state, county, city/town boundaries. An event like the secession from Virginia of West Virginia in 1861 affected boundaries and civil authority, thus the location, administration and care of local records. Using this evaluation, the inventive system either eliminates or includes sources to be searched.

The inventive system is an expert on surnames. Together with the source and geographical location, it identifies and extracts surnames from sources in geographical locations associated with the research question. The inventive system has foreknowledge of many surnames that are and are not in sources for a specific geographical location thereby eliminating or including sources in its search based on that knowledge inputted by the research question.

By geographical location, the inventive system extracts and stores the first occurrence of a given name in derivative or original sources. This is stored with only citations in a database of said names. Together with searching autosomal DNA results, we will be able to compare and contrast surname locations and source origin tracking, the growth and movement of surnames, and connect DNA cousins to the documents of common ancestors 1565-1950.

The BOTs Classes Required to Support this Embodiment are as Follows:
1. Birth, death, marriage, divorce, and Federal State. and County property and tax records are handled by Vital Source Rots.
2. State and county business tax lists state and county court records, state and county business pages, state and county federal reports and state and county penitentiary sources are handled by List Bots.
3. Probate Wills. Plantation Records, deeds, bills of sale, newspapers, obituaries and funeral notices are handled by Public Record Sources BOTs
4. Military Sources BOTs handle service records headstones cemetery records funeral records national genealogy societies sources state county genealogy sources
5. University/College Archive BOTs
6. Public Library Archives BOTs
7. Family History Library Archive BOTs

Source BOTs, geographical location BOTs and surname collector stored procedures are reused for the purposes previously explained.

In collaboration and communication with the above BOT Classes 1-7 who extract and hand off data to Source. Geographical Location and Surname Collector BOTs; to be ranked, stored and saved. This will be used as a basis for selecting sources to search in answer to the inputted research request.

Reader BOTs—using OCR APIs and AI algorithms teach BOTs to read handwriting script in multiple languages. The reader BOTs read original and derivative source documents on a length of film containing microphotographs of documents written in record sources that go on microfilm.

Working in collaboration and communication with Source, Geographical Location, Surname Collector BOTs and any one of the 1-7 BOT classes, Reader BOTs will cooperate as a part of the collaborative team all performing to fulfill the service request and ascertain the answer to the research question.

In collaboration and communication with the above BOTs, readers extract and hand off data to Source. Geographical Location and Surname Collector BOTs: to be ranked, stored and saved as an answer to the inputted research request.

In addition, using OCR APIs with AI algorithms, the Reader BOTs cut down and out the problem Archives and a host of other institutions, has crowdsourcing initiatives, transcribe-a-thons and transcription field days—to type out the nation's mega-trove of handwritten documents for the Web. Reader BOTs read handwriting scripts and transcribe handwriting scripts accurately for archives and other institutions. Using OCR APIs and AI algorithms. BOTs read handwritten scripts in multiple languages. Reader BOTs look at original and derivative source documents on a piece of film that contains microphotographs of millions of documents.

Working in collaboration and communication with Source. Geographical Location, Surname Collectors and any one of the BOT Classes listed above, will have a Reader Bot as a part of the collaborative team to narrow down identified personalities to ascertain the answer to the research question.

In collaboration and communication with the above BOTs, readers extract (translate) and hand off data to Source, Geographical Location and Surname Collector BOTs; to be ranked, stored and saved as an answer to the inputted research request. Successfully fulfilled research requests are stored as cases (per CBR) and either recalled and reused or recalled and adapted when similar requests are made by the user or other users.

By combining OCR APIs with AI algorithms, the Reader Bots read and transcribe. In collaboration with Index Bots, the Reader Personal Helper BOTs take information read transcribed and extracted from historical records and put it into a digital format. This cuts down on and out the issue Archives and a host of other institutions have been using crowdsourcing initiatives and transcription field days to type out the nation's mega-trove of handwritten documents.

### Evaluating Evidence

The inventive system's initial evidence evaluation is done in collaboration with the user to determine and establish a research profile.

Working in collaboration and communication with Source, Geographical Location, Surname Collectors, any BOTs of the 1-7 BOT Classes and Reader BOTs are a collaborative team—all performing to ascertain the answer to the research question, user directive or intent.

### Logic Flow:

1. Categorizes sources: Original. Derivative Authored logs information
2. Is the witness/informant identified?
3. Would they have first-hand knowledge of the information given? Given?
4. If yes-log information as primary If not sure-log information as undetermined if no, log information as secondary
5. Does information answer the research question?
6. If yes, is any information absent that shouldn't be? If no
7. Log description of source
8. Create citation
9. Does the information suggest other sources?
If yes, Access sources and evaluate (steps 1-9)
Has the BOT Team accessed all potentially relevant sources? If yes
Do conflicts exist? No
Compose the GPS Proof Summary

### Returning Results to the User

A report where the answers to the research question, user directive or intent is extracted from web sites original and derivative sources and composed into a document GPS Proof Summary: Source—Cited Text Format and returned to the user.

At least one search intent generates at least one response to the user via the inventive system's Avatar interface engageable by a Browser wherein the communication elements transmit responses to the user in at least one of the following forms:
A list of web links to web sites containing information about the research question.
A multi-media report where the report comprises pictures video audio in addition to text summaries of the search topic by counting, quantifying and composing statistical results about the search topic graphics showing such analytical and statistical summaries about the search question.
Summaries of the search intent results are attained by counting, quantifying and composing statistics about the search intent including graphics showing such analytical and statistical summaries about the search intent results and user responses.

A preferably embodiment of the present inventive system efficiently coordinates specialized BOT classes, each handling a specific type of genealogy search. Through orchestration, the system minimizes redundant searches and maximizes the utilization of retrieved data, ensuring streamlined and effective genealogical research. Such an embodiment employs case-based reasoning AI algorithms, allowing the system to remember successful BOT collaborations. This reusability enables the system to identify similar or identical search patterns and reuse established collaborations. As the system continually learns from past experiences, its performance improves over time, making it faster and more efficient. As such, the disclosed system represents a significant and patentable improvement in genealogical research technology. By providing a unified database search application on a single device, our system streamlines the research process, eliminating the need for multiple database searches. Leveraging the BOT architecture, restful calls, remote procedure calls, and case-based reasoning AI algorithms, our system offers enhanced efficiency, reduced data-volume, and improved performance over time. These advancements make it a transformative solution, significantly improving the field of genealogical research.

In more detail, the library in such a system preferably includes genealogy BOTs that perform searches against historical genealogical data stores are selectively appropriated by the system for processing of the inputted search intents. The BOTs search large volumes of historical records, filter the data to find specific information of interest to the user, and aggregate information of interest to the user disseminated by reports. The system also preferably includes, electronically connected thereto, a database management system for the applicable BOTs. The coordination element therefor includes code that programmatically orchestrates the collaboration among the genealogy BOTs and coordinates activity of the applicable BOT(s), wherein such coordination element interprets the user profile data and user intent, synthesizes a run-time procedure in response to the user intent, translates the data following the synthesis into action steps that invoke the applicable BOT(s), executes such procedure based upon such translations, and generates reports for the user representative of a work of execution procedure of the applicable BOT(s). As in the case of the more general embodiment of the present invention, this particular embodiment may also include an avatar interface electronically connected to the computing unit for communicating at least one such response to the user.

### An Embodiment of the Personal Helper BOT System Applied to Music Playlist Curation

Artists who upload their content on music streaming platforms like Spotify, YouTube, Apple Music, iTunes, Amazon Music, Napster, Deezer, Tidal. and others often face the challenge of finding playlist curators who are interested in featuring their music. Playlist curators receive numerous submissions and requests from artists, making it difficult for artists to stand out and get noticed. Furthermore, playlist curators usually have specific preferences and criteria for the type of music they include in their playlists, which may not align with the artist's genre or style.

The lack of a centralized database or directory of playlist curators also presents a challenge for artists. Artists must engage in extensive research and networking to find and connect with the right curators. Without a solid strategy and approach, artists may struggle to locate the right curators and build a relationship with them.

In the past, even the most persistent and tech-savvy artists who wanted to promote their music through playlists faced a daunting challenge. They had to navigate numerous applications and manually transfer data between them to make any progress. Even assuming that the task could be accomplished on a single device, the computing power and time required were excessive, especially considering that internet searches can process vast amounts of data and produce results within milliseconds.

### Artist Pain Points

The embodiment of the inventive system here solves the problem faced by artists in finding and connecting with playlist curators on music streaming platforms. It aims to identify the strategies and best practices that artists can use to locate and build relationships with playlist curators effectively. The inventive system can benefit aspiring and established artists who wish to promote their music on streaming platforms and enhance their visibility to potential listeners. The central research question that the inventive system helps music artists address is: How can I obtain information that I can trust to accurately describe my target audience, and give me a list of compatible playlist curators I can contact in real time?

The inventive system provides a service that simplifies the process of connecting independent artists with playlist curators who are interested in their music. Typically, finding playlist curators who are willing to feature independent artists can be a time-consuming and challenging task. However, the inventive system utilizes a system of Personal Helper BOTs to identify smaller playlists created by regular consumers that may be more likely to feature independent artists. By targeting these playlists, the inventive system increases the chances of independent artists being discovered and gaining exposure. Additionally, the inventive system processes the playlists of music curators who have expressed interest in connecting with independent artists. This further streamlines the process for independent artists, as they can focus their efforts on reaching out to curators who are already interested in their music. Overall, the inventive system removes the tedious and time-consuming tasks of finding and connecting with playlist curators, making it easier for independent artists to gain exposure and further their careers.

Personal Helper BOTs of the inventive system use machine listening to provide answers for music artists, such as the mood, genre, subgenre, images, song structure, similar artists, song-camelot, popularity, curator keywords, tempo, key, and relationship analysis of lyrics to find compatible playlists.

Machine listening refers to the use of computer algorithms and artificial intelligence (AI) techniques to analyze, interpret, and understand audio signals in a manner like how humans perceive and process sound. It involves the use of signal processing, machine learning, and deep learning methods to extract meaningful information from audio data, such as speech, music, or environmental sounds. Machine listening can have various applications, such as speech recognition, music recommendation, audio event detection, and environmental sound classification.

For example, machine listening algorithms can be used to transcribe spoken words into text, identify songs or artists based on audio features, detect specific sounds like sirens or footsteps in an audio recording, or classify environmental sounds like bird calls or traffic noise. Machine listening is an active area of research in the fields of computer science, artificial intelligence, and signal processing.

The inventive system provides music artists with a wide range of music listening information that can be used to determine the mood, genre, subgenre, song structure, similar artists, song-camelot, song popularity, curator keywords, tempo, key, and relationship analysis of lyrics to find compatible playlists.

The BOTs Classes required to support this Embodiment are as follows:
1. Song Analyzers
2. Mood Extractors
3. Radar Plot Generators
4. Playlist Advisors
5. Fraud Detectors
6. Playlist Evaluators
7. Playlist Report Generators
8. Artist Curator Network Assistants

The Song Analyzers and Mood Extractors examine the acoustic properties of a song to determine its genre, subgenre, and overall mood. These BOTs also compare a song's acoustic features with those of other songs to identify similar artists and recommend relevant playlists. Song Analyzers also use natural language processing (NLP) to identify the song's key themes, sentiment, and word usage. Coordination elements of the Personal Helper BOT System enable the Song Analyzer BOTs to assist Playlist Advisor BOTs to find playlists that align with the lyrical content of the song.

Analyzer BOTs analyze the acoustic features of a song's tempo, rhythm, melody, harmonic structure and other elements to determine its unique sound. Analysis also reveals the emotional content of a song by looking at its frequency and amplitude patterns and capture a labeled snapshot of a sound recording using a set of radar plots that identify the features of a song, allowing them to compare and collect a bucket or container of similar songs and playlists. Radar plots are generated by Radar Plot Generator Bots.

Playlist Advisor BOTs analyze playlist metadata, such as curator keywords and playlist popularity, to recommend playlists that are relevant to an artists music. This advice helps artists target their music to the right curators and listeners.

The inventive system uses three artist research inputs:
1. An audio link to a particular platform containing the artist song.
2. Lyrics and graphic image matching the song being analyzed.
3. Text based contact information, such as email, telephone, and name.

The Playlist Advisor BOTs compile a directory of plots based on the unique features found in each snapshot. This directory is sorted in real-time as the playlist bot collects playlist information based on the collected and weighed information from the snapshots. The collected information is used to generate the genre, key, mood, tempo, lyrics, and other features found in the song spectrum data repository.

Before a playlist can be included in the directory, it must meet three core requirements. The first requirement is a modification check, which ensures that the playlist has been updated with new music within a set period. This check ensures that the playlist is regularly updated and considered fresh. If the playlist meets the freshness requirements, the inventive system Modification bot will pass it on for approval to the Fraud Detector BOTs.

The second requirement is a fraud check, which evaluates the daily rise and decline of followers, historical follower listening activity, and song popularity. This check helps to identify any suspicious activity and ensures that the playlist has legitimate followers who engage with the music.

Finally, once a playlist has passed both the modification and fraud checks, it will be approved for inclusion in the approved directory. However, if the playlist does not contain contact information, such as an Instagram ID or email, it will be cataloged in the rejected directory. The Directory bot of the inventive system collects, catalogs, and compares songs to ensure that the playlist directory is filled with fresh, engaging, and legitimate playlists for artists to improve popularity and listenership.

The approved directory is updated and forwarded as a list of playlists that meet the necessary requirements. The rejected directory is preserved for further analysis, including assessments of popularity, members, and song comparisons. In certain cases, if a rejected directory is deemed ideal for specific reasons, the staff members will manually reach out and attempt to connect with the playlist curator or their allies to provide support and improve the playlist's chances of meeting the necessary requirements for inclusion in the approved directory.

Programming Logic Flow. Once the end user logs into the system and is authenticated—the inventive system utilizes the following programming logic:
1. Artists provide their inputted song data to the inventive system for analysis using acoustic spectrum analysis techniques to determine the song's features, such as tempo, rhythm, melody, harmony, and emotional content.
2. The Artist provides the inventive system Personal Helper BOT System with an explicitly inputted user directive, or intent that describes what the user wants from the system.
3. The analyzed song data is saved and stored in the artist's song spectrum data repository.
4. Radar Plot BOTs generate Radar Plots (statistical graphs, from the artist's analyzed song data to capture a labeled snapshot of the sound recording that identifies the overall features of a song.
5. Radar plots of matching songs are saved and stored in system repositories.
6. Analyzer BOTs compile a genre-sorted directory of sound recording plots based on the unique features found in each saved and store a snapshot as a case in a repository of cases. These cases are like database records later used by Cased Based Reasoning AI algorithms that enable the inventive system to become better and faster by leveraging previous experience.
7. The directory is sorted in real-time as the Playlist Advisor BOTs continually collect playlist information based on the collected and weighed information produced by the Analyzers.
8. Playlist Advisor BOTs check the playlists in the directory for compatibility with the artist's song data, ensuring that they match the desired genre, key, mood, tempo, and other features. If a playlist meets the compatibility requirements of the artist's song data, it is added to the approved directory list. The results also contain potential playlists whose themes may match the primary song's lyrical contents and main genre. If not, it is added to the rejected directory list for further analysis. A distinct collection of similar artists is saved and stored in a similar artist container with the name of the artist and similar song attributes. The inventive system staff manually reaches out to the curators of rejected playlists to provide directory updates and Improve their chances of meeting the compatibility requirements for inclusion in the approved directory container.
9. The approved directory container list is updated and forwarded as a list of playlists that are compatible with the artist's song data.
10. Artists use the inventive system to identify and submit their music to the curated playlists that are compatible with their song data. The inventive system staff continuously monitors and updates different parts of the application to ensure that it remains accurate, relevant, and engaging for artists looking to locate and validate compatible playlists from streaming platforms that collectively have billions of playlists.
11. The inventive system continually updates the Directory container's catalog. As the system gains experience processing song data, each new artist request handling relies more and more on the Directory container's cases and makes fewer requests to streaming platform APIs.
   Playlist Evaluator BOTs perform Real Time Playlist Curator Tracking

Tracking playlist curators in real time is important for several reasons:
1. Freshness: Playlists that are not regularly updated with new music become stale and lose their appeal to listeners. By tracking playlist curators in real time, the inventive system can ensure that the playlists included in the repository of directories are regularly updated with fresh content, keeping the directory relevant and engaging.
2. Fraud prevention: Real-time tracking allows the inventive system to identify any suspicious activity, such as sudden spikes in followers or listening activity, which may indicate fraudulent practices. This helps to ensure that the directory only includes legitimate playlists with genuine followers and engagement. Better curation: By tracking playlist curators in real time.
3. The inventive system can better understand their preferences and behavior, allowing them to make more informed decisions when curating the directory. This can lead to a better selection of playlists that align with the preferences of the intended audience.

Overall, real-time tracking of playlist curators is an essential aspect of ensuring that the directory is regularly updated, free from fraudulent activity, and contains a diverse selection of engaging playlists for listeners. The communication elements of the embodiment of the inventive system here, which include the Report Generator BOTs will produce reports.

In conclusion, the efficient genealogical research system with a Helper BOT architecture provides a patentable improvement over existing technology. By unifying the search process on a single device and leveraging specialized BOT classes, restful calls, and remote procedure calls, our system optimizes genealogical research. The comparisons to Google and Wikipedia searches highlight the efficiency and reduced data volume of genealogical research. The system's intelligent reusability and dynamic learning capabilities ensure continuous performance improvement, making it a groundbreaking solution in the field of genealogical research.

Accordingly, in one preferred embodiment of the present invention, the applicable library includes at least one song analyzer BOT that perform analysis of song metadata are selectively appropriated by the system for processing of the inputted playlist generation intents. The applicable BOT(s) BOTs extract moods from song metadata, organize and process data to generate statistical radar plots, and aggregate information of interest to the user disseminated by reports for the sake of finding the playlists most likely to give the song maximum exposure.

The coordination element includes a code stack that programmatically orchestrates the collaboration among the song analyzer BOTs and coordinates activity of at least one BOT, wherein such coordination element interprets the user profile data and user intent, synthesizes a run-time procedure in response to the user intent, translates the data following the synthesis into action steps that invoke the at least one BOT, executes such procedure based upon such translations, and generates rank-ordered playlist recommendation reports for users representative of a work of execution procedure of the at least one BOT.

Additionally, the system could incorporate an avatar interface within and electronically connected to the system for communicating at least one such response to the user via, the user interface. Such a system would learn to do a task autonomously using case-based reasoning artificial intelligence techniques to learn from prior playlist generations for various songs as the system gains experience generating ranked order playlist recommendations, thus engaging short term memory and long term memory to successfully fulfill requests remembered using such case based reasoning to recall, replay, adapt, and resave with new indices and accordingly removing not only complexity of operation as the number of operations to be used scale up, but also reducing the need to assist such user in the operation.

### ADDITIONAL THOUGHTS

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the inventive apparatus may look and how the inventive process may be performed. Further, other elements and/or steps may be used for and provide benefits to the present invention. The depictions of the present invention as shown in the exhibits are provided for the purposes of illustration.

The embodiments were chosen and described in order to best explain the principles of the invention and its practical application, thereby enabling others of ordinary skill in the art to understand the invention for various embodiments and with various modifications that are suited to the particular use contemplated.

What is claimed:

1. A personal helper BOT system, comprising:
a computing unit for processing data;
a user interface electronically connected to the computing unit;
a storage element for at least one BOT with such storage element electronically connected to the computing unit;
a data input element, electronically connected to the computing unit, through which a user can cause data to be input into the system, wherein such data is recognizable by such computing unit and includes the user's intent for the specific service being requested of the system;
a library of reusable data processing at least one BOTs, with such library electronically connected to the computing unit, from which at least one BOT can be selectively appropriated by the system for processing of the inputted data, wherein such at least one of such BOT validates, organizes, summarizes, creates abstractions, aggregates, classifies, filtrates, prioritizes, calculates, otherwise creates, disseminates or otherwise processes data;
a coordination element within and electronically connected to the computing unit that further details the collaboration via at least one BOT and coordinates activity of such at least one BOT, wherein such coordination element interprets the inputted data for such at least one BOT, synthesizes a procedure in response to the data, translates the data following the synthesis into action steps that invoke such at least one BOT, executes such procedure based upon such translations, and generates at least one response representative of a work of execution procedure of such at least one BOT; and
a communications element within and electronically connected to the computing unit for communicating at least one such response to the user via the user interface;
wherein such BOT system learns to do a task autonomously using case based reasoning artificial intelligence techniques to learn from prior use of the BOT system, thus engaging short term memory and long term memory to successfully fulfill requests remembered using such case based reasoning to recall, replay, adapt, and resave with new indices and accordingly removing not only complexity of operation as the number of operations to be used scale up, but also reducing the need to assist such user in the operation.

2. The system of claim 1, wherein the system uses a previously captured procedures modified based upon the new data.

3. A personal helper BOT system interacting with a video displaying device and interoperable with external functionality via remote procedure calls, and utilization of APIs, comprising:
a computing unit for processing data;
a storage element within and electronically connected to the computing unit for a team of BOTs;
a user interface within and electronically connected to the computing unit comprising a personal assistant in the form of a customizable avatar;
a data input element within and electronically connected to the computing unit through which a user can cause data, recognizable by such computing unit, to be input into the system;
an authentication element within and electronically connected to the computing unit that can confirm the user's identity;
a receptor within and electronically connected to the computing unit that receives results of a search by the at least one BOT based upon data caused to be the inputted data by the user previously;
a storage element within and electronically connected to the computing unit for inputted data and search results within the system;
a coordination element within and electronically connected to the computing unit that coordinates an activity of such team of BOTs, wherein such coordination element interprets the inputted data for such team of BOTs, synthesizes a procedure in response to the data, translates the data following the synthesis into action steps that invoke a team of BOTs, executes such procedure based upon such translations, and generates at least one response to such device representative of a work of the team of BOTs;
a communications element within and electronically connected to the computing unit for communicating at least one such response to the user via the user interface, wherein the at least one BOT is invoked to ensure that at least one generated response is secure and at least one such response is customized based in part upon specific data; and
wherein such BOT system learns to do a task autonomously using case-based reasoning artificial intelligence techniques to learn from prior use of the BOT system, thus engaging short term memory and long term memory to successfully fulfill requests remembered using such case based reasoning to recall, replay, adapt, and resave with new indices and accordingly removing not only the complexity of operation as the number of applications to be used scale up, but also reducing the need to assist such user in operation.

4. The system of claim 1 wherein the inputted data includes information from at least one of the following categories:
Demographic Information:
User Name
Optional Password
Date of Birth
City of Birth
Primary phone number
Secondary phone number
Email Address
Street Address
City
State
Zip Code
Country
Emergency Contact Name
Emergency Contact Phone Number
Emergency Contact Email
Financial Information:
Bank Names
Bank Account Numbers
Bank Routing Numbers
Credit Card Types
Credit Card Account Numbers
Credit Card Expiration Dates
Other Payment Method
Other Payment Method Name
Other Payment Method Account Number
Personal information:
Popular social media environments including friend list, family list, and significant other
Popular applications including shopping sites, and search engines
BOT-enabled applications and web sites
Health Information:
Blood Type
Blood Pressure Category as Normal, Borderline, High
Family Health History Information
Known Medical Conditions as Hypertension, Disorders, Diseases, etc.
Date of most recent hospital or clinic encounter
Description of most recent encounter
Food Allergies as Peanut, Seafood, etc.
Most Recent Pulse with Date/Time
Most Recent Blood Pressure Reading with Date/Time
Entertainment information:
Preferences for how you like to experience entertainment including:
Alone
With Family including members of Family List and Effective Date
With Friends including members of Friend List and Effective Date
With Significant Other as Romantic, Platonic and Effective Date
Preferences for what kinds of things you like to watch including TV shows, Movies:
Drama
Action
Comedy
Other
Preferences for what categories of things the user might like to consume comprising a method for allowing the user to indicate said preferences in ranked order:
Sports events as Boxing, Fishing, Basketball, etc.
Movies as per specific Movie Preferences as Drama, Comedy etc.
TV Shows as Home Improvement, Nature, etc.
Sitcoms as specified by user
Value Preferences indicating on a scale from 1 to 10, the user's willingness to watch programs containing that type of program content.
Sexual Tolerance
Profanity Tolerance
Nudity Tolerance
Violence Tolerance
Educational Content
A value preference indicator that indicates for each value preference if the user is for (1) or against (0) the type of program content.
Security Preferences that enable the user to indicate what data items they would like to protect with Internet security.
Settings information:
Demographic
Health
Financial
Social
Other
Configuration settings:
Amount of time in minutes before an event to be notified about event
Dollar limits set for automatic purchases

5. The system of claim 1 wherein the system can actively elicit service requests from a user, interpret user directives, disambiguate among competing directives, request, and receive clarifying directives or canceling directives as needed, and carry out or initiate service requests based on the understanding of the directive.

6. The system of claim 1 wherein the library is comprised of a digital architecture, a user-directed search filter, and security architecture.

7. The system of claim 6 wherein the digital library architecture is interoperable with a repository of digital documents and helps the user plan activities associated with the consumption of the documents and wherein the communications element generates at least one response to the user that entails the work execution of at least one BOT wherein the work entails the service of organizing documents for consumption in a manner consistent with inputted data from the user.

8. The system of claim 7 in which the storing element comprises of a library of searchable elements of possible interest to at least one user, wherein such elements can be ranked within categories according to the likelihood that at least one user will find at least one element of interest.

9. The system of claim 1 further comprises a user-directed search filter, wherein the system processes inputted data that directly includes directives incorporating search criteria to execute scripts that coordinate at least one invoked BOT that performs search functions, wherein at least one search function comprises search algorithms including
processing and filtering the search results of an existing search engine, and
the rank ordering among digital documents of interest to the user for those embodiments of the system that are interoperable with a repository of digital documents and
at least one search function generates at least one response to the user via at least one user interface via at least one device, wherein the communication element can transmit such response to the user in at least one of the following forms:
a list of web links to web sites containing information about the search keywords.
a report where the searched for content is extracted from web sites of interest and composed into a document and is returned to the searcher
a multi-media report where the report comprises pictures and video in addition to text
summaries of the search topic by counting, quantifying and composing statistical results about the search topic
graphics showing such analytical and statistical summaries about the search topic.

10. The system of claim 9 wherein the system is electronically connectable to an external search engine that processes request using various information elements.

11. The system of claim 1 wherein the selected inputted data can be interpreted and the selection is the result of a financial transaction.

12. The system of claim 11 wherein the user can input data recognizable to the system as an intent to add or subtract at least one BOT to or from the BOT system as a result of a financial transaction with a BOT store comprising purchasable selections of useful teams comprising at least one BOT.

13. The system of claim 1 further comprises a security architecture, wherein the coordination element synthesizes a procedure for authenticating the user comprising:
the translation of the inputted data into action steps that invoke at least one Security BOT,
the execution of the authentication procedure based on at least one translation, and
the generation of at least one response representative of a work of authentication procedure comprising but not limited to verification of data that had been inputted prior to the authentication event.

14. A method of providing information responsive to a user's inputted data comprising steps of
receiving such data through a user interface engageable via a device;
converting such data into a form recognizable by at least one BOT;
coordinating the activity of at least one such BOT, wherein such coordination includes steps of interpreting such data by the at least one such BOT, synthesizing at least one procedure in response to such data, translating such data following the synthesis into action steps that invoke the at least one BOT, executing such procedure based upon such translations, and generating at least one response to such device representative of a work of at least one BOT;
communicating at least one such response to the user via the user interface; and
learning to do a task autonomously in the performance of the foregoing steps using case-based reasoning artificial intelligence techniques to learn from prior activities, thus engaging system short term memory and long-term memory to successfully fulfil requests remembered using such case-based reasoning to recall, replay, adapt, and resave with new indices, removing the complexity of operation as the number of applications to be used scale up.

15. The system of claim 1 wherein
such library includes genealogy BOTs that perform searches against historical genealogical data stores are selectively appropriated by the system for processing of the inputted search intents; wherein BOTs search large volumes of historical records, filter the data to find specific information of interest to the user, and aggregate information of interest to the user disseminated by reports;
such system includes, electronically connected to the system, a database management system for at least one BOT; and
such coordination element includes code that programmatically orchestrates the collaboration among the genealogy BOTs and coordinates activity of at least one BOT, wherein such coordination element interprets the user profile data and user intent, synthesizes a run-time procedure in response to the user intent, translates the data following the synthesis into action steps that invoke the at least one BOT, executes such procedure based upon such translations, and generates reports for the user representative of a work of execution procedure of the at least one BOT.

16. The system of claim 15 wherein the system further comprises an avatar interface electronically connected to the computing unit for communicating at least one such response to the user.

17. The system of claim 1 wherein
such library includes at least one song analyzer BOT that perform analysis of song metadata are selectively appropriated by the system for processing of the inputted playlist generation intents, wherein further such at least one BOTs extracts moods from song metadata, organize and process data to generate statistical radar plots, and aggregate information of interest to the user disseminated by reports for the sake of finding the playlists most likely to give the song maximum exposure; and
such coordination element includes a code stack that programmatically orchestrates the collaboration among the song analyzer BOTs and coordinates activity of at least one BOT, wherein such coordination element interprets the user profile data and user intent, synthesizes a run-time procedure in response to the user intent, translates the data following the synthesis into action steps that invoke the at least one BOT, executes such procedure based upon such translations, and generates rank-ordered playlist recommendation reports for users representative of a work of execution procedure of the at least one BOT; and
an avatar interface within and electronically connected to the system for communicating at least one such response to the user via, the user interface;
wherein such ROT system learns to do a task autonomously using case based reasoning artificial intelligence techniques to learn from prior playlist generations for various songs as the system gains experience generating ranked order playlist recommendations, thus engaging short term memory and long term memory to successfully fulfill requests remembered using such case based reasoning to recall, replay, adapt, and resave with new indices and accordingly removing not only complexity of operation as the number of operations to be used scale up, but also reducing the need to assist such user in the operation.

18. The system of claim 17 wherein the system further comprises an avatar interface electronically connected to the computing unit for communicating at least one such response to the user.
